(19) United States
(12) Patent Application Publication
(10) Pub. No.: US 2018/0160699 A1
(43) Pub. Date: Jun. 14, 2018

(54) PROCESS FOR PRODUCING A SEED SLURRY AND APPARATUS THEREFORE

(71) Applicant: AAK AB (publ), Malmö (SE)

(72) Inventors: Morten Daugaard ANDERSEN, Højbjerg (DK); Bjarne JUUL, Tranbjerg J (DK)

(21) Appl. No.: 15/580,580

(22) PCT Filed: Jun. 9, 2016
(86) PCT No.: PCT/SE2016/050556

§ 371 Date: Dec. 7, 2017

(30) Foreign Application Priority Data
Jun. 10, 2015 (SE) 1550786-6

(51) Int. Cl. A23G 1/48; A23D 9/04; C11C 3/10

(52) U.S. Cl. CPC A23G 1/48; G01N 25/4866; C11C 3/10; A23D 9/04

(57) ABSTRACT

A process for producing a seed slurry (SSY) in a seed slurry apparatus (SSA) from solid seed particles (SSP) is disclosed, the seed slurry apparatus (SSA) comprising an input zone (IZ) and a heating zone (HZ), the input zone (IZ) feeding the heating zone (HZ) and the heating zone (HZ) comprising a heating arrangement (HA), said process comprising the steps of feeding the solid seed particles (SSP) from the input zone (IZ) into the heating zone (HZ), the solid seed particles having a seed composition, the seed composition comprising triglycerides, heating said seed composition in said heating zone (HZ) by means of said heating arrangement (HA) to obtain a seed slurry (SSY) at least partly on the basis of partly melted seed composition, wherein said heating involves measuring a seed slurry temperature representation of the seed slurry and said heating is at least partly controlled on the basis of the measured seed slurry temperature representation. Furthermore, a seed slurry apparatus (SSA) and use of a seed slurry (SSY) and a seed slurry apparatus (SSA) is disclosed.

### FIELD OF THE INVENTION

The invention relates to the field of confectionary products, such as chocolates and chocolate-like products, and particularly to a process of its production, said chocolate or chocolate-like product having improved heat and/or bloom stability.

### BACKGROUND

It is known that confectionary products, such as chocolate, produced from a chocolate composition may be susceptible to disadvantageous processes, such as bloom formation. One very used process used to address this problem is to subject the chocolate composition to tempering whereby at least some resistance to bloom formation is obtained. Disadvantages of the tempering process include that it is complicated, time consuming and energy-consuming process, and that the obtained product may not have a desired sufficiently low susceptibility of e.g. bloom formation.

### SUMMARY

The invention relates in first aspect to a process for producing a seed slurry in a seed slurry apparatus from solid seed particles,

the seed slurry apparatus comprising an input zone and a heating zone, the input zone feeding the heating zone and the heating zone comprising a heating arrangement, said process comprising the steps of
feeding the solid seed particles from the input zone into the heating zone, the solid seed particles having a seed composition, the seed composition comprising triglycerides,
heating said seed composition in said heating zone by means of said heating arrangement to obtain a seed slurry at least partly on the basis of partly melted seed composition,
wherein said heating involves measuring a seed slurry temperature representation of the seed slurry and said heating is at least partly controlled on the basis of the measured seed slurry temperature representation.

The invention relates in a further aspect to a seed slurry apparatus for producing a seed slurry from solid seed particles having a seed composition, the seed composition comprising triglycerides,

said seed slurry apparatus comprising
a heating zone,
a heating arrangement arranged to heat the seed composition in said heating zone,
a temperature representation measuring arrangement arranged to measure a seed slurry temperature representation of said seed slurry, and
a control unit,
   wherein said temperature representation measuring arrangement is arranged to transmit a measuring signal to said control unit, said measuring signal being based at least partly on the measured seed slurry temperature representation,
   wherein said control unit is arranged to control the heating arrangement based at least partly on the measuring signal.

The invention relates in a still further aspect to a use of a seed slurry apparatus SSA according to any of its embodiments in production of a seed slurry.

The invention relates in an even further aspect to a seed slurry obtainable by a process according to any of its embodiments and/or by a seed slurry apparatus according to any of its embodiments.

The invention relates in a still even further aspect to a use of a seed slurry according to any of its embodiments, or a seed slurry obtainable according to the process according to any of its embodiments, or a seed slurry obtainable according to the use of the seed slurry apparatus in any of its embodiments, in production of confectionary products, such as chocolate or chocolate-like products.

### THE FIGURES

The invention will be described in the following with reference to the drawings, where

FIG. 1 illustrate the principles of a process and a seed slurry apparatus according to an embodiment of the invention,

FIG. 2 illustrates a further embodiment of a seed slurry apparatus according to the invention,

FIG. 3-5 illustrate different applicable control parameters within the scope of the invention,

FIGS. 6 and 7 illustrate different regulation techniques within the scope of the invention where the x-axis refers to a time and the y-axis refers to a temperature,

FIG. 8 illustrates a heat exchanger applied for melting solid seed particles,

FIG. 9 illustrates a heat exchanger comprising a set of scrape surface tubes,

FIG. 10 illustrates a batch embodiment of a seed slurry apparatus according to an embodiment of the invention,

FIG. 11 illustrates a principle DSC curve related to a specific use of a seed slurry apparatus according to an embodiment of the invention where the x-axis refers to a temperature and the y-axis is given in Watts per gram, and where

FIG. 12 illustrate two principle DSC curves related to a specifically chosen composition of a solid seed particle according to an embodiment of the invention where the x-axis refers to a temperature and the y-axis may be given e.g. in Watts per grams.

### LIST OF FIGURE REFERENCES

SSA. Seed slurry apparatus
TRMA. Temperature representation measuring arrangement
TMA. Temperature measuring arrangement
VMA. Viscosity measuring arrangement
SNi. Section i
SSP. Solid seed particles
SSY. Seed slurry
CU. Control unit
STI. Stirrer
HZO. Heating zone outlet
2. Shaft
3. Conveyor screw
6. Heat transfer compartment
7. Temperature regulated compartment
8. Temperature regulated fluid inlet
9. Temperature regulated fluid outlet
10. Temperature sensor

### DETAILED DESCRIPTION

### Definitions

As used herein, the term “fatty acid” encompasses free fatty acids and fatty acid residues in triglycerides.

As used herein “edible” is something that is suitable for use as food or as part of a food product, such as a dairy or confectionary product. An edible fat is thus suitable for use as fat in food or food product and an edible composition is a composition suitable for use in food or a food product, such as a dairy or confectionary product.

As used herein, “%” or “percentage” all relates to weight percentage i.e. wt. % or wt.-% if nothing else is indicated.

As used herein, the singular forms “a”, “an” and “the” include plural referents unless the context clearly dictates otherwise.

As used herein, “at least one” is intended to mean one or more, i.e. 1, 2, 3, 4, 5, 6, 7, 8, 9, 10, etc.

As used herein, “vegetable oil” and “vegetable fat” is used interchangeably, unless otherwise specified.

As used herein, the term “apparatus” refer to a set of materials or equipment designed for a certain use. Consequently, the claimed apparatus may be established as a single device or it may be defined as a number of co-working devices together performing the required process. The process may preferably be defined to be automated with no, little or substantial human interaction along the line.

As used herein, the term “endotherm melt peak position” may refer to the position of a melt peak, which may be the main endotherm melt peak or it may be a smaller melt peak.

As used herein, the term “triglycerides” may be used interchangeably with the term ‘triacylglycerides’ and should be understood as an ester derived from glycerol and three fatty acids. “Triglycerides” may be abbreviated TG or TAG. A single triglyceride molecule, having a specific molecular formula, is of either vegetable or non-vegetable origin. Some triglycerides, like for example StOSt-triglycerides, may be obtained from both vegetable and/or non-vegetable sources. Thus a fat phase comprising StOSt-triglycerides, may comprise StOSt-triglycerides obtained solely from vegetable sources or StOSt-triglycerides obtained solely from non-vegetable sources or a combination thereof i.e. the fat phase may comprise some StOSt-triglyceride molecules obtained from vegetable sources and some StOSt-triglycerides molecules obtained from non-vegetable sources.

As used herein, the term “vegetable” shall be understood as originating from a plant retaining its original chemical structure/composition. Thus, a vegetable fat or vegetable triglycerides are still to be understood as vegetable fat or vegetable triglycerides after fractionation etc. as long as the chemical structure of the fat components or the triglycerides are not altered. When vegetable triglycerides are for example transesterified they are no longer to be understood as a vegetable triglyceride in the present context.

Similarly, the term “non-vegetable” in the context of “non-vegetable triglyceride” or “non-vegetable fat” when used herein is intended to mean obtained from other sources than native vegetable oils or fractions thereof, or obtained after transesterification. Examples of non-vegetable triglycerides may for example be, but are not limited to, triglycerides obtained from unicellular organisms, animal fat, and/or transesterification.

As used herein, “transesterification” should be understood as replacing one or more of the fatty acid moieties of a triglyceride with another fatty acid moiety or exchanging one or more fatty acid moieties from one triglyceride molecule to another. A fatty acid moiety may be understood as a free fatty acid, a fatty acid ester, a fatty acid anhydride, an activated fatty acid and/or the fatty acyl part of a fatty acid. The term ‘transesterification’ as used herein may be used interchangeably with ‘interesterification’. The transesterification process may be an enzymatic transesterification or chemical transesterification. Both chemical transesterification and enzymatic transesterification is described well in the art. Both chemical and enzymatic transesterification may be done by standard procedures.

As used herein “seed” is intended to mean a composition comprising at least some fat crystals capable of seeding a chocolate.

As used herein, the term “slurry” is a partly melted composition, where at least some seed crystals are present. Thus a “slurry” may also be understood as a partly melted suspension, partly molten suspension or a paste. Therefore, the term “seed slurry” refers to a slurry comprising at least some seed crystals present in the seed slurry.

As used herein, the term “bloom resistance” refers to a property of the chocolate to resist bloom formation. Increased or improved bloom resistance in a chocolate in the present context thus implies that the chocolate has a higher resistance towards surface blooming.

As used herein, the term “fraction” shall in this regard be understood to be a product remaining after a physical separation of the constituents of a natural source of a fat. This product may subsequently be subjected to a transesterification.

As used herein, the term “seed slurry temperature representation” may be a temperature measure as such, another measure which may be interpreted to ensure that the desired temperature limit or limits are complied with in the heating zone. Moreover, it should be understood that at least in some embodiments, it may be possible to control the viscosity at least to some degree by controlling the heating, thereby ensuring that a maximum viscosity is not exceeded, i.e. that the viscosity allows a flowable yet not fully melted composition. Thus, it should be understood that at least for some embodiments, said seed slurry temperature representation may also be understood as a seed slurry viscosity representation, e.g. in the sense that, from the seed slurry temperature representation and, optionally, further information, such as information about the seed composition, information about the viscosity may be deducted. In some cases approximate values of the viscosity may even be deducted. This also applies vice versa. Thus, as an example, information, such as approximate values, about the viscosity may be deducted from the temperature, and vice versa. In some embodiments the viscosity may be used to achieve the desired consistency of the seed slurry and in some embodiments the temperature may be used to achieve the desired consistency of the seed slurry.

As used herein “partly melted” is intended to mean not totally melted and not totally solid or crystalline. Within a temperature range from Tlow to Thigh the seed product has to be melted enough to be pumpable, and may not be melted to an extent that no seed crystals capable of seeding chocolate remains. In certain embodiments partly melted may be understood more narrow, for example that a certain percentage is melted and a certain percentage is non-melted, i.e. solid or crystalline. This may for example be represented by the solid fat content (SFC). Several methods for measuring SFC are known in the art.

As used herein a “chocolate” is to be understood as chocolate and/or chocolate-like products. Some chocolate comprises cocoa butter, typically in substantial amounts, where some chocolate-like product may be produced low or even without cocoa butter, e.g. by replacing the cocoa butter with cocoa butter equivalent, cocoa butter substitute, etc. Also, many chocolate products comprises cocoa powder or cocoa mass, although some chocolate products, such as typical white chocolates, may be produced without cocoa powder, but e.g. drawing its chocolate taste from cocoa butter. Depending on the country and/or region there may be various restrictions on which products may be marketed as chocolate. By a chocolate product is meant a product, which at least is experienced by the consumer as chocolate or as a confectionery product having sensorial attributes common with chocolate, such as e.g. melting profile, taste etc.

As used herein the term “solid seed particles” is intended to mean solid particles of a seed. The particles may be in various forms, examples of which include flakes, pellets, granules, chips, and powder. The solid seed particles are for use in seeding chocolate.

This may optionally be done in combination with conventional tempering steps.

### Abbreviations

Sat=saturated fatty acid/acyl-group
U=unsaturated fatty acid/acyl-group
St=stearic acid/stearate
A=arachidic acid/arachidate
B=behenic acid/behenate
Lig=lignoceric acid/lignocerate
O=oleic acid/oleate

### DSC=Differential Scanning Calorimetry

Moreover, the invention relates to a process for producing a seed slurry SSY in a seed slurry apparatus SSA from solid seed particles SSP,

the seed slurry apparatus SSA comprising an input zone IZ and a heating zone HZ, the input zone IZ feeding the heating zone HZ and the heating zone HZ comprising a heating arrangement HA,
said process comprising the steps of
feeding the solid seed particles SSP from the input zone IZ into the heating zone HZ, the solid seed particles having a seed composition, the seed composition comprising triglycerides,
heating said seed composition in said heating zone HZ by means of said heating arrangement HA to obtain a seed slurry SSY at least partly on the basis of partly melted seed composition,
wherein said heating involves measuring a seed slurry temperature representation of the seed slurry and said heating is at least partly controlled on the basis of the measured seed slurry temperature representation.

One significant advantage of the invention may be that an industrial applicable and pumpable seed slurry may be obtained without compromising the seeding capability of the seed composition by retaining desired seed crystals in the seed composition while melting unwanted lower melting point crystals.

One important advantage of the invention may be that a seed slurry may be obtained having a sufficient content of high melting seed crystals, which may be effective for seeding crystallization of high melting crystals in a chocolate composition, and at the same time having a sufficiently low content of lower melting crystals, e.g. substantially without any lower melting crystals. Thus, a seed slurry being effective for seeding a confectionary composition, such as a chocolate or chocolate-like composition, may be obtained. Thereby, a confectionary product, such as a chocolate or chocolate-like product, having improved heat and/or bloom stability may be obtained.

The seed slurry has significant advantages compared to a solid seed, such as for example a powdery seed, when used for seeding chocolate. The miscibility with chocolate may be faster and more homogeneous, since the lowest melting fats and crystal polymorphic forms of the seed slurry are melted. The highest melting crystal polymorphic forms are thus already in a partly melted environment in the seed slurry, when the seed slurry is mixed with chocolate, which may prevent lumping. Furthermore, the temperature of the at least partly melted seed slurry is higher than that of solid seed particles, and may thus be closer to the temperature of the chocolate when mixed together, which may also improve the miscibility with chocolate and prevent lumping of fat crystals. Chocolate is typically completely melted when mixed with a seed.

One important advantage of the invention may be that solid seed particles may be processed into a seed slurry being mixable and pumpable, which may especially be useful in an industrial setting, while at the same time being effective for seeding a confectionary composition.

It should be understood that the seed slurry is obtained at least partly on the basis of partly melted seed composition, i.e. the seed slurry is obtained at least partly on the basis of seed composition where the seed composition is partly melted.

Another important advantage of the invention is that the seed slurry is produced from solid seed particles, which can be partially melted in a controlled fashion to melt the lowest melting fats crystal polymorphic forms and retain the highest melting crystal polymorphic forms that were already present in the solid seed particles.

In order to obtain a seed slurry which may be used to seed a chocolate composition efficiently, it is important to ensure that the seed slurry is not heat to a temperature so high that all seed crystals are melted. Thus, according to an advantageous embodiment of the invention, said heating is controlled to obtain a seed slurry comprising seed crystals. One very important advantage of this embodiment may be that by controlling the heating such that a seed slurry comprising seed crystals is obtained, a very effective seed slurry is obtained. The seed slurry may thus be provided as a mixable slurry, i.e. a slurry which may be fast and easy to mix with other ingredients, substantially without any lower melting crystals, but with a sufficient amount of seed crystals effective for seeding, e.g. seeding chocolate or a chocolate-like composition, which may be used to produce a confectionary product, such as a chocolate or chocolate-like product.

When obtaining a seed slurry comprising seed crystals, it is important to control the heating precisely. Therefore, according to an advantageous embodiment of the invention, said heating involves measuring a seed slurry temperature representation of the seed slurry and said heating is at least partly controlled on the basis of the measured seed slurry temperature representation to obtain a seed slurry comprising seed crystals. As emphasized by this embodiment, the seed slurry comprises seed crystals, i.e. un-melted seed, which may be utilized to ensure effective seeding of a confectionary product, such as a chocolate or chocolate-like product. Thus, one advantage of this embodiment may be that a resulting final confectionary product, such as a chocolate or chocolate-like product, having improved bloom stability may be obtained when using said seed slurry. Moreover, an important advantage of this embodiment may be that the seed slurry may be very effective in production of a final confectionary product, such as a chocolate or chocolate-like product, since it is provided as a mixable slurry, which may be fast and easy to mix with other ingredients, but also may induce or improve bloom stability in the final product.

In order to obtain a seed slurry having the desired ability to seed chocolate and chocolate-like products, it is important to use a seed composition having seed crystals. Thus, according to an advantageous embodiment of the invention, said seed composition comprises seed crystals. One significant advantage of this embodiment may be that since the seed composition comprises seed crystals, the resulting seed slurry may also comprise seed crystals when controlling the heating of said seed composition in said heating zone.

In order to ensure that the seed composition comprises seed crystals, the solid seed particles should comprise seed crystals. Therefore, according to an advantageous embodiment of the invention, said solid particles comprise seed crystals.

Thereby, and when controlling the other parameters correctly, hereunder the heating, a seed slurry comprising seed crystals may be obtained. Therefore, according to an advantageous embodiment of the invention, said seed slurry comprises seed crystals.

In order to obtain a seed slurry having the desired advantages and ability to seed chocolate and chocolate-like products, the specific composition of the seed crystals may be adjusted so as to improve the seeding effect of the seed slurry. According to an advantageous embodiment of the invention, said seed composition comprises triglycerides in an amount of 60.0-99.9% by weight of said seed composition, such as 70.0-99.9% by weight, such as 80.0-99.9% by weight, such as 90.0-99.9% by weight, such as 95.0-99.0% by weight. One advantage of this embodiment may be that a final chocolate product with a relatively high triglyceride content may be obtained using the solid seed particles.

According to an embodiment of the invention, the seed composition is substantially free of non-fat components, such as sugar or cocoa powder. Thus, the seed composition may have a non-fat content of less than 5% by weight, such as less than 1% by weight, such as less than 0.1% by weight.

The present inventor has discovered that having a relatively high content of SatOSat-triglycerides in the seed composition may improve the seeding effect of the obtained seed slurry. Thus, according to an advantageous embodiment of the invention, said seed composition comprises SatOSat-triglycerides in an amount of 40.0-99.9% by weight of said triglycerides, such as 50.0-99.9% by weight, such as 60.0-99.9% by weight, such as 70.0-99.9% by weight, such as 80-99.9% by weight, wherein Sat is a saturated fatty acid, and wherein O stands for oleic acids.

Other examples of the content of SatOSat-triglycerides in the seed composition includes when said seed composition comprises SatOSat-triglycerides in an amount of 40.0-99.0% by weight of said triglycerides, such as 50.0-99.0% by weight, such as 70.0-99.0% by weight, such as 80.0-99.0% by weight, such as 60.0-95.0% weight, such as 70.0-95.0% by weight, such as 50.0-90.0% by weight, wherein Sat is a saturated fatty acid, and wherein O stands for oleic acids.

Particularly, it may be important to have a relatively high content of high melting SatOSat-triglycerides in order to the heat stability of the seed slurry and of a resulting confectionary product, such as a chocolate or a chocolate-like product. Thus, according to a further advantageous embodiment of the invention, said seed composition comprises 40.0-99.9% by weight of said triglycerides of triglycerides having C18-C24 saturated fatty acids in the sn-1 and sn-3 positions and oleic acid in the sn-2 position, such as 50.0-99.9% by weight, such as 60.0-99.9% by weight, such as 70.0-99.9% by weight, such as 80.0-99.9% by weight.

Other examples of the content of high melting SatOSat-triglycerides in the seed composition includes when said seed composition comprises 40.0-99.0% by weight of said triglycerides of triglycerides having C18-C24 saturated fatty acids in the sn-1 and sn-3 positions and oleic acid in the sn-2 position, such as 50.0-99.0% by weight, such as 70.0-99.0% by weight, such as 80.0-99.0% by weight, such as 60.0-95.0% weight, such as 70.0-95.0% by weight, such as 50.0-90.0% by weight.

Triglycerides having C18-C24 saturated fatty acids in the sn-1 and sn-3 positions and oleic acid in the sn-2 position” are examples of SatOSat triglycerides. It should be understood that the saturated fatty acids in the sn-1 and the sn-3 positions may not necessarily be the same, although they may be in some cases. Examples of such triglycerides include StOSt, StOA, StOB, StOLig, AOA, AOB, AOLig, BOB, BOLig, and LigOLig.

Triglycerides having C18-C24 saturated fatty acids in the sn-1 and sn-3 positions and oleic acid in the sn-2 position may also comprise a combination of two or more of the triglycerides StOSt, StOA, StOB, StOLig, AOA, AOB, AOLig, BOB, BOLig, and LigOLig, where these triglycerides are comprised in an amount of 30.0-99.0% by weight of the triglycerides having C18-C24 saturated fatty acids in the sn-1 and sn-3 positions and oleic acid in the sn-2 position, such as 40.0-99.0% by weight, such as 50.0-99.0% by weight, such as 60.0-99.0% by weight, such as 70.0-99.0% by weight.

It may be important to have a relatively high amount of higher melting SatOSat-triglycerides compared to lower melting triglycerides of cocoa butter. Therefore, according a further advantageous embodiment of the invention, a weight-ratio in the seed composition between
triglycerides having C18-C24 saturated fatty acids in the sn-1 and sn-3 positions and oleic acid in the sn-2 position and
triglycerides having C16-C24 saturated fatty acids in the sn-1 and sn-3 positions and oleic acid in the sn-2 position
   is between 0.40-0.99, such as 0.45-0.99, such as 0.50-0.99, such as 0.55-0.99, such as 0.60-0.99, such as 0.65-0.99, such as 0.70-0.99. In the present context it should of course be understood that the weight-ratio of this embodiment is the weight-ratio in the seed composition between Sat(C18-C24)OSat(C18-C24) triglycerides and Sat(C16-C24)OSat(C16-C24) triglycerides, wherein said Sat(C18-C24)OSat(C18-C24) triglycerides are triglycerides having C18-C24 saturated fatty acids in the sn-1 and sn-3 positions and oleic acid in the sn-2 position, and wherein said Sat(C16-C24)OSat(C16-C24) triglycerides are triglycerides having C16-C24 saturated fatty acids in the sn-1 and sn-3 positions and oleic acid in the sn-2 position. Examples of lower melting triglycerides of cocoa butter, i.e. triglycerides being part of triglycerides having C16-C24 saturated fatty acids in the sn-1 and sn-3 positions and oleic acid in the sn-2 position but not part of triglycerides having C16-C24 saturated fatty acids in the sn-1 and sn-3 positions and oleic acid in the sn-2 position, include primarily POP-triglycerides and POSt triglycerides.

One example of a higher melting SatOSat-triglyceride is StOSt-triglycerides. Therefore, according to a further advantageous embodiment of the invention, said seed composition comprises StOSt-triglycerides in an amount of 30.0-99.0% by weight of said triglycerides, such as 40.0-99.0% by weight, such as 50.0-99.0% by weight, such as 60.0-99.0% by weight, such as 70.0-99.0% by weight, wherein St stands for stearic acid and O stands for oleic acid. One advantage of this embodiment may be that StOSt-triglycerides are found in natural cocoa butter and that many StOSt-triglyceride rich sources have a relatively high compatibility and miscibility with cocoa butter and also that StOSt-triglycerides may be obtained via various sources, such as naturals, which are relatively abundant.

Other examples of the content of StOSt-triglycerides in the seed composition includes when said seed composition comprises StOSt-triglycerides in an amount of 30.0-99.0% by weight of said triglycerides, such as 40.0-90.0% by weight, such as 50.0-90.0%, such as 50.0-80.0% by weight, wherein St stands for stearic acid and O stands for oleic acid.

Another example of a higher melting SatOSat-triglyceride is AOA-triglycerides. Thus, according to an even further advantageous embodiment of the invention, said seed composition comprises AOA-triglycerides in an amount of 30.0-99.0% by weight of said triglycerides, such as 40.0-99.0% by weight, such as 50.0-99.0% by weight, such as 60.0-99.0% by weight, such as 70.0-99.0% by weight, wherein A stands for arachidic acid and O stands for oleic acid. One advantage of this embodiment may be that by using AOA-triglycerides which transforms from solid to liquid form at relatively high temperatures, the solid seed particles may have an increased heat resistance and, particularly, an obtained final confectionary product, such as a chocolate or chocolate-like product, may be have an increased heat resistance.

Other examples of the content of AOA-triglycerides in the seed composition includes when said seed composition comprises AOA-triglycerides in an amount of 30.0-99.0% by weight of said triglycerides, such as 40.0-90.0% by weight, such as 50.0-90.0%, such as 50.0-80.0%, wherein A stands for arachidic acid and O stands for oleic acid.

Yet another example of a higher melting SatOSat-triglyceride is BOB-triglycerides. Therefore, in an even further advantageous embodiment of the invention, said seed composition comprises BOB-triglycerides in an amount of 30.0-99.0% by weight of said triglycerides, such as 40.0-99.0% by weight, such as 50.0-99.0% by weight, such as 60.0-99.0% by weight, such as 70.0-99.0% by weight, wherein B stands for behenic acid and O stands for oleic acid. One advantage of this embodiment may be that by using BOB-triglycerides which transforms from solid to liquid form at relatively high temperatures, the solid seed particles may have an increased heat resistance and, particularly, an obtained final confectionary product, such as a chocolate or chocolate-like product, may be have an increased heat resistance.

Other examples of the content of BOB-triglycerides in the seed composition includes when said seed composition comprises BOB-triglycerides in an amount of 30.0-99.0% by weight of said triglycerides, in an amount of 40.0-90.0% by weight, such as 50.0-90.0%, such as 50.0-80.0%, wherein B stands for behenic acid and O stands for oleic acid.

A still further example of a higher melting SatOSat-triglyceride is LigOLig-triglycerides. Thus, in yet one further advantageous embodiment of the invention, said seed composition comprises LigOLig-triglycerides in an amount of 30.0-99.0% by weight of said triglycerides, such as 40.0-99.0% by weight, such as 50.0-99.0% by weight, such as 60.0-99.0% by weight, such as 70.0-99.0% by weight, wherein Lig stands for lignoceric acid and O stands for oleic acid. One advantage of this embodiment may be that by using LigOLig-triglycerides which transforms from solid to liquid form at relatively high temperatures, the solid seed particles may have an increased heat resistance and, particularly, an obtained final confectionary product, such as a chocolate or chocolate-like product, may be have an increased heat resistance.

Other examples of the content of LigOLig-triglycerides in the seed composition includes when said seed composition comprises LigOLig-triglycerides in an amount of 30.0-99.0% by weight of said triglycerides, in an amount of 40.0-90.0% by weight, such as 50.0-90.0%, such as 50.0-80.0%, wherein Lig stands for lignoceric acid and O stands for oleic acid.

Since the heating is at least partly controlled on the basis of the measured seed slurry temperature representation, establishing this seed slurry temperature representation is important to heat in the desired controlled way. Different options exist with regard to the specific position where the seed slurry temperature representation is measured. According to a further advantageous embodiment of the invention, said seed slurry temperature representation is measured in heating zone HZ, at a heating zone output HZO, and/or at an output O of said a seed slurry apparatus SSA.

According to an even further advantageous embodiment of the invention, said seed slurry temperature representation is measured at a point where it is possible to derive or obtain a temperature of the produced seed slurry.

The seed slurry temperature may be established and measured in many direct or indirect sensor configurations in the sense that the positioning of the used sensor may vary, the number of sensors may vary and the type of the sensors may vary. It is also important to understand that the seed slurry temperature representation may be derived from applicable non-temperature measures as long as the main objective is reached, namely measuring a parameter and controlling the heating of the heating arrangement to ensure that the seed particles are partly melted into a slurry which is pumpable while still ensuring that at least some of the seed crystals of the solid seed particles are maintained as crystals in the seed slurry.

The seed slurry temperature representation may be based on a directly measured temperature, or it may be based on a measurement of another physical variable, from which a temperature may be calculated or estimated. Thus, according to a further advantageous embodiment of the invention, measuring said seed slurry temperature representation comprises measuring a seed slurry temperature. It should be noted, however, that an actual calculation or estimation of a temperature may not necessarily take place, e.g. since the process may be controlled according to another parameter, such as for example viscosity, and where the actual limits of this parameter has previously been established as acceptable with respect to the obtained seed slurry and its characteristics.

Alternatively, or in combination therewith, measuring said seed slurry temperature representation comprises measuring a seed slurry viscosity.

By measuring a seed slurry temperature, the heating may be controlled so as to not exceed a maximum temperature, at which the seed slurry may have melted or melted to a too high extend. Thus, according to an advantageous embodiment of the invention, said heating is at least partly controlled on the basis of the measured seed slurry temperature representation to provide a slurry having a temperature below a maximum temperature (Tmax). I.e. the seed slurry is provided as a slurry having a temperature below a maximum temperature (Tmax).

Alternatively, or in combination therewith, said heating is at least partly controlled on the basis of the measured seed slurry temperature representation to provide a slurry having a viscosity below a maximum viscosity (VISCMAX). I.e. the seed slurry is provided as a slurry having a temperature below a maximum viscosity (VISCMAX) thus ensuring that the seed slurry has satisfactory characteristics with respect to mixability, e.g. with a chocolate composition, and/or pumpability, i.e. that the seed slurry can be transported by means of pumping.

According to a further embodiment of the invention, said heating involves measuring at least two seed slurry temperature representations of the seed slurry, and wherein said heating is at least partly controlled on the basis of two or more measured seed slurry temperature representations. Thereby, the characteristics, such as viscosity and/or temperature of the seed slurry may be determined more accurately, whereby the characteristics of the seed slurry may be significantly improved.

As stated above, the measuring of the seed slurry temperature representation may involve measuring both a seed slurry temperature and a seed slurry viscosity. Thus, according to one embodiment, the at least two measured seed slurry temperature representations comprises at least a measured temperature and a measured viscosity.

One further embodiment is where the at least two measured seed slurry temperature representations comprises at least two measured temperatures.

A still further embodiment is where the at least two measured seed slurry temperature representations comprises at least two measured viscosities.

An even still further embodiment of the invention is where said at least two seed slurry representations are measured at different points in said seed slurry apparatus SSA.

In order to establish a seed slurry being partly melted, the degree of melting may be used as a guide for controlling the heating. According to an advantageous embodiment of the invention said seed composition being partly melted has a melted content of 40-99% by weight, such as 50-98% by weight, such as 60-98% by weight, such as 70-98% by weight, such as 70-95% by weight, such as 80-90% by weight.

The percentage of the seed composition being melted may be determined by various methods available in the art. Such methods may e.g. include measuring the Solid Fat Content (SFC) and therefrom determining the melted content as 100% minus the SFC at a given temperature.

Other examples of partly melted seed composition includes when the seed composition being partly melted has a melted content of 40-98% by weight, such as 40-95% by weight, such as 40-90% by weight, such as 40-80% by weight.

Further examples of partly melted seed composition includes when the seed composition being partly melted has a melted content of 50-99% by weight, such as 50-95% by weight, such as 50-90% by weight, such as 50-80% by weight.

Still further examples of partly melted seed composition includes when the seed composition being partly melted has a melted content of 60-99% by weight, such as 60-95% by weight, such as 60-90% by weight, such as 60-80% by weight.

Even further examples of partly melted seed composition includes when the seed composition being partly melted has a melted content of 70-99% by weight, such as 70-95% by weight, such as 70-90% by weight, such as 70-80% by weight.

Still even further examples of partly melted seed composition includes when the seed composition being partly melted has a melted content of 80-99% by weight, such as 80-95% by weight, such as 80-90% by weight.

In order to establish a seed slurry being partly melted, heating in relation to specific endotherm melt peaks positions of a DSC thermogram may be used. Thus, according to a further advantageous embodiment of the invention, the heating is controlled to a temperature below a form VI endotherm melt peak position. The form VI endotherm melt peak position may for example be identified from a DSC thermogram (i.e. a melting thermogram obtained by Differential Scanning Calorimetry (DSC)) of the used solid seed particles.

For example, the endotherm melt peak position may be measured by Differential Scanning Calorimetry (DSC) by heating samples of 40+/−4 mg of said seed slurry from 32 degrees Celsius to 65 degrees Celsius at a rate of 3 degrees Celsius per minute to produce a melting thermogram defining the endotherm melt peak position

According to a further advantageous embodiment of the invention, the heating is controlled to a temperature above a form IV endotherm melt peak position. The form IV endotherm melt peak position may for example be identified from a DSC thermogram of the used solid seed particles.

The use of the endotherm melt peaks positions as a guide for controlling the heating in relation to the seed slurry temperature representation may be used when the seed composition has a relatively high content of StOSt-triglycerides. According to an even further advantageous embodiment of the invention the heating is controlled to a temperature below the endotherm melt peak position of the highest melting crystal polymorphic form of StOSt-triglycerides. The highest melting crystal polymorphic form of StOSt-triglycerides is believed to be form VI also known as form beta1, which has a melting point of approximately 43 degrees Celsius.

According to a still further advantageous embodiment of the invention, the heating is controlled to a temperature above the endotherm melt peak position of the third-highest melting crystal polymorphic form of StOSt-triglycerides. The third-highest melting crystal polymorphic form of StOSt-triglycerides is believed to be form IV also known as form beta′, which has a melting point of approximately 36.5 degrees Celsius.

The use of the endotherm melt peaks positions as a guide for controlling the heating in relation to the seed slurry temperature representation may be used when the seed composition has a relatively high content of AOA-triglycerides. According to an advantageous embodiment of the invention, the heating is controlled to a temperature below the endotherm melt peak position of the highest melting crystal polymorphic form of AOA-triglycerides. The highest melting crystal polymorphic form of AOA-triglycerides is believed to be form VI also known as form beta1, which has a melting point of approximately 48.3 degrees Celsius.

According to an advantageous embodiment of the invention, the heating is controlled to a temperature above the endotherm melt peak position of the third-highest melting crystal polymorphic form of AOA-triglycerides. The third-highest melting crystal polymorphic form of AOA-triglycerides is believed to be form IV also known as form pseudo-beta′, which has a melting point of approximately 46.5 degrees Celsius.

The use of the endotherm melt peaks positions as a guide for controlling the heating in relation to the seed slurry temperature representation may be used when the seed composition has a relatively high content of BOB-triglycerides. According to an advantageous embodiment of the invention, the heating is controlled to a temperature below the endotherm melt peak position of the highest melting crystal polymorphic form of BOB-triglycerides. The highest melting crystal polymorphic form of BOB-triglycerides is believed to be form VI also known as form beta1, which has a melting point of approximately 53 degrees Celsius.

According to an advantageous embodiment of the invention, the heating is controlled to a temperature above the endotherm melt peak position of the third-highest melting crystal polymorphic form of BOB-triglycerides. The third-highest melting crystal polymorphic form of BOB-triglycerides is believed to be form V also known as form beta2′, which has a melting point of approximately 50.5 degrees Celsius.

The use of the endotherm melt peaks positions as a guide for controlling the heating in relation to the seed slurry temperature representation may be used when the seed composition has a relatively high content of LigOLig-triglycerides. According to an advantageous embodiment of the invention, the heating is controlled to a temperature below the endotherm melt peak position of the highest melting crystal polymorphic form of LigOLig-triglycerides.

According to an advantageous embodiment of the invention, the heating is controlled to a temperature above the endotherm melt peak position of the third-highest melting crystal polymorphic form of LigOLig-triglycerides.

One way of controlling the heating involves heating to a temperature at which the seed slurry is partly melted. According to a further advantageous embodiment of the invention, the seed composition is partly melted within a temperature range from Tlow to Thigh.

Thus, according to an advantageous embodiment of the invention, said heating is controlled to keep the temperature of the seed composition within the temperature range from Tlow to Thigh.

In different situations, the actual degree of melting required for obtaining a seed slurry may vary, e.g. due to the specific content of triglycerides in the seed composition and the amount, composition, and form of other components in the seed composition. Thus, the temperatures at which the seed slurry is partly melted may vary accordingly. In one further advantageous embodiment of the invention, the temperature Tlow is the temperature at which 40% by weight of said triglycerides are melted, such as 50% by weight, such as 60% by weight, such as 70% by weight, such as 80% by weight.

According to a further embodiment of the invention, wherein the amount of said triglycerides being melted is determined from a solid fat content (SFC) measurement.

According to a still further embodiment of the invention, the temperature Tlow is the temperature at which 45% by weight of the said triglycerides are melted, such as 55% by weight, such as 65% by weight, such as 75% by weight, such as 85% by weight.

According to an even further advantageous embodiment of the invention, the temperature Thigh is the temperature at which 99% by weight of said triglycerides are melted, such as 98% by weight, such as 95% by weight, such as 90% by weight, such as 85% by weight, such as 80% by weight, such as 75% by weight, such as 70% by weight, such as 65% by weight.

According to a still even further advantageous embodiment of the invention, the temperature Tlow is at least 25 degrees Celsius, such as at least 30 degrees Celsius, such as at least 35 degrees Celsius, such as at least 38 degrees Celsius, such as at least 39 degrees Celsius, such as at least 40 degrees Celsius.

As an example, the temperature Tlow may be 25 degrees Celsius.

As a further example, the temperature Tlow may be 30 degrees Celsius.

As a still further example, the temperature Tlow may be 35 degrees Celsius.

As an even further example, the temperature Tlow may be 36 degrees Celsius.

As an even still further example, the temperature Tlow may be 37 degrees Celsius.

As a yet further example, the temperature Tlow may be 38 degrees Celsius.

As an even further example, the temperature Tlow may be 39 degrees Celsius.

As a still further example, the temperature Tlow may be 40 degrees Celsius.

At the same time, the seed composition may be kept below a temperature Thigh, in order to ensure that the seed composition is partly melted and not completely melted. According to an advantageous embodiment of the invention, the temperature Thigh is no more than 42 degrees Celsius, such as no more than 41 degrees Celsius, such as no more than 40 degrees Celsius.

The specific temperature Thigh may in some cases vary, due to e.g. the specific triglyceride composition and crystal content, and/or of any additional components.

As an example, the temperature Thigh may be 42 degrees Celsius.

As a further example, the temperature Thigh may be 41 degrees Celsius.

As a still further example, the temperature Thigh may be 40 degrees Celsius.

Thus, in one embodiment the temperature range from Tlow to Thigh may e.g. be from 25 to 42 degrees Celsius.

In another embodiment the temperature range from Tlow to Thigh may e.g. be 30 to 42 degrees Celsius.

In a further embodiment the temperature range from Tlow to Thigh may e.g. be 35 to 42 degrees Celsius.

In a still further embodiment the temperature range from Tlow to Thigh may e.g. be 40 to 42 degrees Celsius.

In an even further embodiment the temperature range from Tlow to Thigh may e.g. be 38 to 41 degrees Celsius.

In a still even further embodiment the temperature range from Tlow to Thigh may e.g. be 39 to 41 degrees Celsius.

Thus, it may be understood that the temperature Thigh is the lowest temperature where the seed slurry obtained from the process of the invention is free from seed crystals or approximately 1-2 degrees Celsius below the temperature where the seed crystals in the seed slurry would be completely melted. I.e. this temperature may be determined by heating part of seed slurry and determining if any seed crystals remain in the seed slurry. According to one embodiment of the invention, this may be measured e.g. by means of a DSC profile, e.g. as described in various embodiments herein. In certain alternative embodiments, other criteria known within the art may be used to determine if any seed crystals remain. E.g. by measuring the solid fat content (SFC), it can be determined if any seed crystals are left in the slurry, if the solid fat content is above zero. For example, if a chocolate product obtained from a seeded chocolate composition, the seeded chocolate composition comprising the seed slurry, experiences premature bloom, e.g. compared to a seeded or tempered chocolate, this may indicate that no or only an insignificant amount of seed crystals remained.

The specific value of the temperature Thigh may vary considerably due to the specific content and form of triglycerides and other components in the seed composition.

Thus, according to an embodiment of the invention, the temperature Thigh is no more than 42 degrees Celsius, such as no more than 41 degrees Celsius, such as no more than 40 degrees Celsius, such as no more than 39 degrees Celsius; and the temperature Tlow is at least 38 degrees Celsius, such as at least 39 degrees Celsius, such as at least 40 degrees Celsius, such as at least 41 degrees Celsius; and the seed composition comprises StOSt-triglycerides in an amount of 30.0-99.0% by weight of said triglycerides, such as 40.0-99.0% by weight, such as 50.0-99.0% by weight, such as 60.0-99.0% by weight, such as 70.0-99.0% by weight, wherein A stands for arachidic acid and O stands for oleic acid.

According to a further embodiment of the invention, the temperature Thigh is no more than 49 degrees Celsius, such as no more than 48 degrees Celsius, such as no more than 47 degrees Celsius, such as no more than 46 degrees Celsius, such as no more than 45 degrees Celsius, such as no more than 44 degrees Celsius; and the temperature Tlow is at least 43 degrees Celsius, such as at least 44 degrees Celsius, such as at least 45 degrees Celsius, such as at least 46 degrees Celsius, such as at least 47 degrees Celsius; and the seed composition comprises AOA-triglycerides in an amount of 30.0-99.0% by weight of said triglycerides, such as 40.0-99.0% by weight, such as 50.0-99.0% by weight, such as 60.0-99.0% by weight, such as 70.0-99.0% by weight, wherein A stands for arachidic acid and O stands for oleic acid.

According to a still further embodiment of the invention, the temperature Thigh is no more than 54 degrees Celsius, such as no more than 53 degrees Celsius, such as no more than 52 degrees Celsius, such as no more than 51 degrees Celsius, such as no more than 50 degrees Celsius, such as no more than 49 degrees Celsius; and the temperature Tlow is at least 47 degrees Celsius, such as at least 48 degrees Celsius, such as at least 49 degrees Celsius, such as at least 50 degrees Celsius, such as at least 51 degrees Celsius, such as at least 52 degrees Celsius; and the seed composition comprises BOB-triglycerides in an amount of 30.0-99.0% by weight of said triglycerides, such as 40.0-99.0% by weight, such as 50.0-99.0% by weight, such as 60.0-99.0% by weight, such as 70.0-99.0% by weight, wherein A stands for arachidic acid and O stands for oleic acid.

Another option may be to measure a seed slurry temperature representation comprising a seed slurry viscosity. Thus, according to an advantageous embodiment of the invention, the heating is controlled to obtain a seed slurry having a Brookfield Plastic viscosity of less than 1500 cP (BPV), such as less than 1200 cP (BPV), such as less than 1000 cP (BPV), such as less than 800 cP (BPV), such as less than 700 cP (BPV), such as less than 600 cP (BPV). One advantage of this embodiment may be that by ensuring a sufficiently low viscosity, an acceptable temperature range may be obtained. Thus, the viscosity may be a seed slurry temperature representation, since the temperature may be determined or estimated from the viscosity, e.g. when also knowing the composition of the seed composition.

According to a further advantageous embodiment of the invention, the heating is controlled to obtain a seed slurry having a Brookfield Plastic viscosity of at least 40 cP (BPV), such as at least 50 cP (BPV), such as at least 60 cP (BPV), such as at least 70 cP (BPV), such as at least 80 cP (BPV), such as at least 100 cP (BPV).

According to an embodiment of the invention, the viscosity of the seed slurry is determined by a Brookfield DV-III, software version 3.3, with a Huber ministat 240 cooling system where a 10 mL of a sample with a temperature corresponding to the temperature of the seed slurry in the heating zone were placed in a SC4-13RPY sample chamber and where the sample chamber was at the same temperature as the sample and where a spindle SC4-27 was placed into the sample in the sample chamber and the samples were initially stirred at isothermal temperature (a temperature corresponding to the temperature of the seed slurry in the heating zone) for 2 minutes at 50 RPM and then in 30 seconds intervals at 5, 10, 15, 20, 25, 30, 35, 40, 45, 50 RPM and where Brookfield Plastic viscosity (BPV) is given in Centipoise (cP) and Brookfield Yield Value (BYV) is given in Dynes/cm².

It may in some cases be desired that the solid seed particles are provided having a specific size distribution. Thus, according to an advantageous embodiment of the invention, the solid seed particles have a mean diameter of 0.1 micrometer to 10000 micrometer, such as a mean diameter of 1 micrometer to 1000 micrometer, wherein the solid seed particles have a size distribution having a full width at half maximum of 0.1 to 1000 micrometer.

According to a further embodiment of the invention, the solid seed particles have a mean diameter of 0.1 micrometer to 10000 micrometer, such as a mean diameter of 1 micrometer to 1000 micrometer.

According to an even further embodiment of the invention, the solid seed particles have a size distribution having a full width at half maximum of 0.1 to 1000 micrometer.

The seed composition may comprise triglycerides from various sources. In one advantageous embodiment of the invention, said seed composition comprises triglycerides obtained from vegetable sources. Examples of such vegetable fats include fats selected from the group consisting of fats obtained from shea, sunflower, rapeseed, sal, kokum, illipe, mango, mowra, cupuacu, allanbackia, pentadesma, and any fraction and/or any combination thereof.

According to a further advantageous embodiment of the invention, said seed composition comprises triglycerides obtained from non-vegetable sources.

One example of the seed composition comprises triglycerides obtained from non-vegetable sources is where said seed composition comprises triglycerides obtained from a unicellular organism. For example, said unicellular organism is selected from the group consisting of bacteria, algae or fungi, wherein fungi comprise yeast and mold.

One example of the seed composition comprises triglycerides obtained from non-vegetable sources is where said seed composition comprises triglycerides obtained by transesterification or interesterification. In this context transesterification being defined as exchanging the R group of a triglyceride ester with the R′ group of an alcohol. Furthermore, in this context interesterification is defined as exchanging fatty acids from one triglyceride molecule to another. For example said triglycerides are obtained from an edible fat, such as a vegetable fat, and a saturated fatty acid source under the influence of enzymes having 1,3-specific transesterification activity.

One example of the seed composition comprises triglycerides obtained from non-vegetable sources is where said triglycerides are obtained from an edible fat, such as a vegetable fat, and a saturated fatty acid source under the influence of an acid, a base or a non-enzymatic catalyst or any combination thereof.

For example, said saturated fatty acid source comprises stearic acid or stearic acid esters, such as stearic acid methyl ester.

In another example, said saturated fatty acid source comprises arachidic acid or arachidic acid esters, such as arachidic acid methyl ester.

In a further example, said saturated fatty acid source comprises behenic acid or behenic acid esters, such as behenic acid methyl ester.

In an even further example, said saturated fatty acid source comprises lignoceric acid or lignoceric acid esters, such as lignoceric acid methyl ester.

According to a further embodiment of the invention, the edible fat used for transesterification comprises a vegetable fat selected from a group consisting of fats obtained from shea, sunflower, soy, rapeseed, sal, safflower, palm, soy, kokum, illipe, mango, mowra, cupuacu and any fraction and any combination thereof.

According to a further embodiment of the invention, said vegetable fat is high oleic sunflower, high oleic safflower oil, high oleic rapeseed oil or any combination thereof.

According to an even further embodiment of the invention, said seed composition comprises a shea olein or a shea olein fraction.

The seed composition may comprise a certain level of lower melting oils. Thus, in an embodiment of the invention, the seed composition comprise oils with a melting point below 25 degrees Celsius in an amount of 1.0-42% by weight, such as 3.0-35% by weight, such as 3.5-27%, such as 5-20% by weight.

In an embodiment of the invention, the seed composition comprise oils selected from the group consisting of sunflower oil, high oleic sunflower oil, soybean oil, rape seed oil, high oleic rape seed oil, soy oil, olive oil, maize oil, peanut oil, sesame oil, hazelnut oil, almond oil, corn oil, or fractions or mixtures or any combination thereof.

In order to establish a seed slurry having desired abilities for seeding a confectionary product, such as a chocolate or a chocolate-like product, it may be important to ensure certain characteristics in the input product, the output product or an intermediate product. Specifically, it may be desired to ensure a relatively high endotherm melt peak position. Thus, according to an advantageous embodiment of the invention, said solid seed particles exhibit an endotherm melt peak position at a value being about 40 degrees Celsius or higher, said endotherm melt peak position being measured by Differential Scanning Calorimetry by heating samples of 40+/−4 mg of said solid seed particles from 32 degrees Celsius to 65 degrees Celsius at a rate of 3 degrees Celsius per minute to produce a melting thermogram defining said endotherm melt peak position.

According to a further advantageous embodiment of the invention, said heating is controlled to obtain said seed slurry exhibiting an endotherm melt peak position at a value being about 40 degrees Celsius or higher, said endotherm melt peak position being measured by Differential Scanning Calorimetry by heating samples of 40+/−4 mg of said solid seed particles from 32 degrees Celsius to 65 degrees Celsius at a rate of 3 degrees Celsius per minute to produce a melting thermogram defining said endotherm melt peak position.

According to a further advantageous embodiment of the invention, said step of heating comprises mixing said solid seed particles SSP and/or said seed slurry SSY. One important advantage of this embodiment may be that by mixing the solid seed particles SSP and/or said seed slurry SSY while heating, a relatively uniform temperature distribution throughout the solid seed particles SSP and/or said seed slurry SSY may be obtained, thus ensuring e.g. that one part of the solid seed particles SSP and/or said seed slurry SSY is not overheated or that one part of the solid seed particles SSP and/or said seed slurry SSY is too cold and completely un-melted.

In further embodiments, the specific content of certain triglycerides and the temperature Tlow and Thigh may have specific relations. Thus, according to an advantageous embodiment of the invention, said seed composition comprises StOSt-triglycerides in an amount of 30.0-99.0% by weight of said triglycerides, wherein St stands for stearic acid and O stands for oleic acid, and the temperature range from Tlow to Thigh may be 25 to 42 degrees Celsius.

According to a further advantageous embodiment of the invention, said seed composition comprises StOSt-triglycerides in an amount of 30.0-99.0% by weight of said triglycerides, wherein St stands for stearic acid and O stands for oleic acid, and the temperature range from Tlow to Thigh may be 30 to 42 degrees Celsius.

According to an even further advantageous embodiment of the invention, said seed composition comprises StOSt-triglycerides in an amount of 30.0-99.0% by weight of said triglycerides, wherein St stands for stearic acid and O stands for oleic acid, and the temperature range from Tlow to Thigh may be 35 to 42 degrees Celsius.

According to a still further advantageous embodiment of the invention, said seed composition comprises StOSt-triglycerides in an amount of 30.0-99.0% by weight of said triglycerides, wherein St stands for stearic acid and O stands for oleic acid, and the temperature range from Tlow to Thigh may be 38 to 42 degrees Celsius.

According to a further advantageous embodiment of the invention, said seed composition comprises StOSt-triglycerides in an amount of 30.0-99.0% by weight of said triglycerides, wherein St stands for stearic acid and O stands for oleic acid, and the temperature range from Tlow to Thigh may be 39 to 41 degrees Celsius.

According to an even further advantageous embodiment of the invention, said seed composition comprises AOA-triglycerides in an amount of 30.0-99.0% by weight of said triglycerides, wherein A stands for stearic acid and O stands for oleic acid, and the temperature range from Tlow to Thigh may be 46 to 48 degrees Celsius.

According to a still even further advantageous embodiment of the invention, said seed composition comprises BOB-triglycerides in an amount of 30.0-99.0% by weight of said triglycerides, wherein B stands for behenic acid and O stands for oleic acid, and the temperature range from Tlow to Thigh may be 51 to 53 degrees Celsius.

According to an advantageous embodiment, said melting thermogram is obtained by Differential Scanning Calorimetry (DSC) by a METTLER TOLEDO DSC 823e with a HUBER TC45 immersion cooling system, where 40+/−4 mg samples of the chocolate confectionery product is hermetically sealed in a 100 microliter aluminum pan with an empty pan as reference to produce a DSC melting thermogram

Moreover, the invention relates to a seed slurry apparatus SSA for producing a seed slurry from solid seed particles SSP having a seed composition, the seed composition comprising triglycerides, said seed slurry apparatus SSA comprising
a heating zone HZ,
a heating arrangement HA arranged to heat the seed composition in said heating zone HZ,
a temperature representation measuring arrangement TRMA arranged to measure a seed slurry temperature representation of said seed slurry SSY, and
a control unit CU,
   wherein said temperature representation measuring arrangement TRMA is arranged to transmit a measuring signal MS to said control unit CU, said measuring signal MS being based at least partly on the measured seed slurry temperature representation, wherein said control unit CU is arranged to control the heating arrangement HA based at least partly on the measuring signal MS.

According to an embodiment of the invention, said heating arrangement is provided as a part of the heating zone.

The seed slurry temperature representation may, according to various embodiments, comprise a seed slurry temperature and/or a seed slurry viscosity. Therefore, according to an advantageous embodiment of the invention, said temperature representation measuring arrangement TRMA comprises a temperature measuring arrangement TMA adapted to measure at least one temperature.

According to a further advantageous embodiment of the invention, said temperature representation measuring arrangement TRMA comprises a viscosity measuring arrangement VMA adapted to measure at least one viscosity.

According to even further advantageous embodiment of the invention, said seed slurry apparatus SSA further comprises
a memory circuit MC,
   wherein the control unit CU is arranged to control the heating arrangement HA at least partly on the basis of said predetermined entries in said memory circuit MC.

According to a still further advantageous embodiment of the invention, said seed slurry apparatus SSA further comprises a mixing arrangement, wherein the mixing arrangement STI, 3 is arranged in the heating zone HZ to mix said solid seed particles SSP and/or said seed slurry SSY.

According to an advantageous embodiment of the invention, said seed slurry apparatus SSA is adapted to operate in accordance with the process according to any of its embodiments.

Moreover, the invention relates to a use of a seed slurry apparatus SSA according to any of its embodiments in production of a seed slurry.

Moreover, the invention relates to a seed slurry obtainable by a process any of its embodiments, by a seed slurry apparatus according to any of its embodiments.

Moreover, the invention relates to a use of a seed slurry according to any of its embodiments, or a seed slurry obtainable according to the process according to any of its embodiments, or a seed slurry obtainable according to the use of the seed slurry apparatus according to any of its embodiments, in production of confectionary products, such as chocolate or chocolate-like products. The use of the seed slurry according to the invention in any of its embodiments for seeding chocolate has significant advantages compared to the use of solid seeds. The seed slurry may have a more homogeneous miscibility with chocolate, since the seed is already in a at least partly melted state, when being mixed with chocolate. Additionally, the seed slurry may be mixed faster, since lumping of crystals, which may be seen with powdery seeds, may be prevented.

According to an embodiment of the invention, the production of chocolate in which the seed slurry may be used is production without any tempering steps. One significant advantage of this embodiment may be that the production time and cost may be reduced while producing a comparable or even better chocolate product.

According to an embodiment of the invention, the production of chocolate in which the seed slurry may be used is production with at least one tempering step. One advantage of this embodiment may be that the tempering may be shortened. Thus, the production time and cost may be reduced while producing a comparable or even better chocolate product.

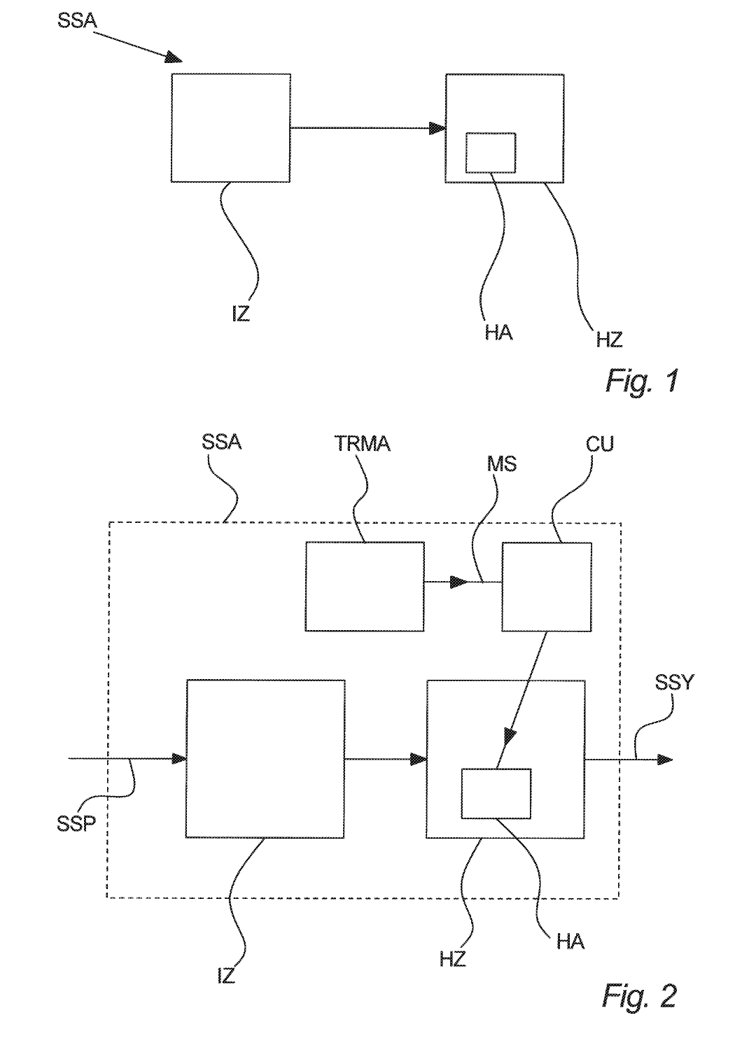

Referring to FIG. 1, a process for producing a seed slurry in a seed slurry apparatus from solid seed particles SSP is illustrated according to an embodiment of the invention.

The seed slurry apparatus SSA comprising an input zone IZ and heating zone HZ. The input zone IZ is arranged to feed the heating zone HZ. The heating zone HZ comprises a heating arrangement HA.

The process comprises the following steps comprises at a first and a second step.

A first step comprises feeding the solid seed particles SSP from the input zone IZ into the heating zone HZ. The solid seed particles SSP have a seed composition, comprising triglycerides.

The second step comprises heating the seed composition in the heating zone HZ by means of the heating arrangement HA. Thereby, a seed slurry is obtained at least partly on the basis of partly melted seed composition. The heating of the second step involves a measuring of a seed slurry temperature representation of the seed slurry. Moreover, the heating is at least partly controlled on the basis of the measured seed slurry temperature representation.

Now referring to FIG. 2 a seed slurry apparatus SSA according to an embodiment of the invention is illustrated. The seed slurry apparatus SSA is adapted to produce a seed slurry SSY from solid seed particles SSP comprising SatOSat-triglycerides.

As illustrated, the seed slurry apparatus SSA comprises a heating zone HZ and a heating arrangement HA arranged to heat the SatOSat-triglycerides in the heating zone HZ.

The seed slurry apparatus SSA further comprises a temperature representation measuring arrangement TRMA and a control unit CU.

The temperature representation measuring arrangement TRMA is arranged to measure a seed slurry temperature representation of the seed slurry SSY. The temperature representation measuring arrangement TRMA is further arranged to transmit a measuring signal MS to the control unit CU based at least partly on the measured seed slurry temperature representation.

The control unit CU is arranged to control the heating arrangement HA based at least partly on the measuring signal MS.

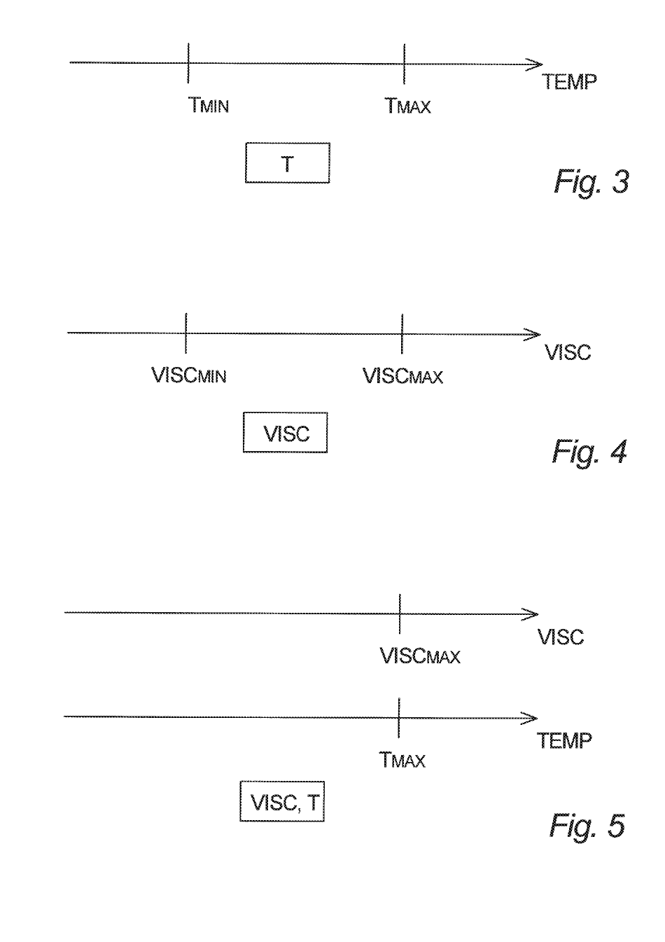

FIG. 3 to FIG. 5 illustrates different understandings of a seed slurry temperature representation as a foundation for heating within the scope of the invention.

FIG. 3 illustrates a sensor setup where the heating regulation is obtained through use of temperature sensors outputting values directly correlated to actual temperatures. The applied sensors are applied to control the heating of solid seed particles into a seed slurry where the lowest temperature Tlow is set to ensure that the lower form crystal are melted and Thigh is selected to ensure that the seed crystals are not completely melted.

FIG. 4 illustrates a variant of the setup where viscosity sensors are applied as a foundation for the regulation of the heating. A low viscosity VISCMIN is set to ensure that the solid seed particles are not overheated and that the solid seed particles are not completely melted.

A high viscosity VISCMAX is set to ensure that the solid seed particles are partly melted in the sense that the lower form crystals of the solid seed particles are melted.

It is noted that the viscosity as an effective control parameter is understood as a seed slurry temperature representation within the scope of the invention due to the fact that viscosity parameters, at least the minimum viscosity VISCMIN may be set to ensure that the maximum temperature is not exceeded and that the seed crystals contained in the solid seed particles are never completely melted.

FIG. 5 illustrates a further embodiment where the regulation of heating temperature is based on a hybrid sensor setup, i.e. sensors measuring both viscosity and temperature. The VISCMAX is set to ensure that the solid seed particles are partly melted in the sense that the lower form crystals of the seed are melted and Tmax is selected to ensure that the seed composition is not completely melted.

A great advantage in one embodiment is where viscosity is chosen as a result effective control parameter due to the fact that the direct setting of heating temperatures must be correlated to the formulation of the applied solid seed particles, whereas viscosity is a relative value potentially equally applicable for different formulations without any requirement of switching between control algorithms, i.e. temperature settings.

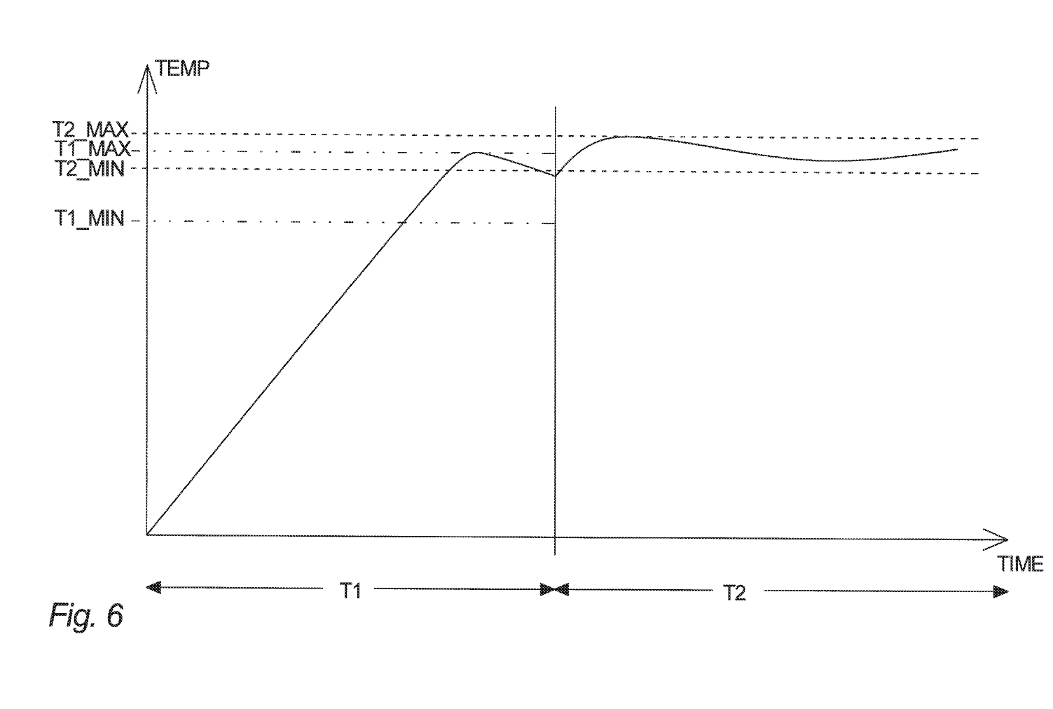

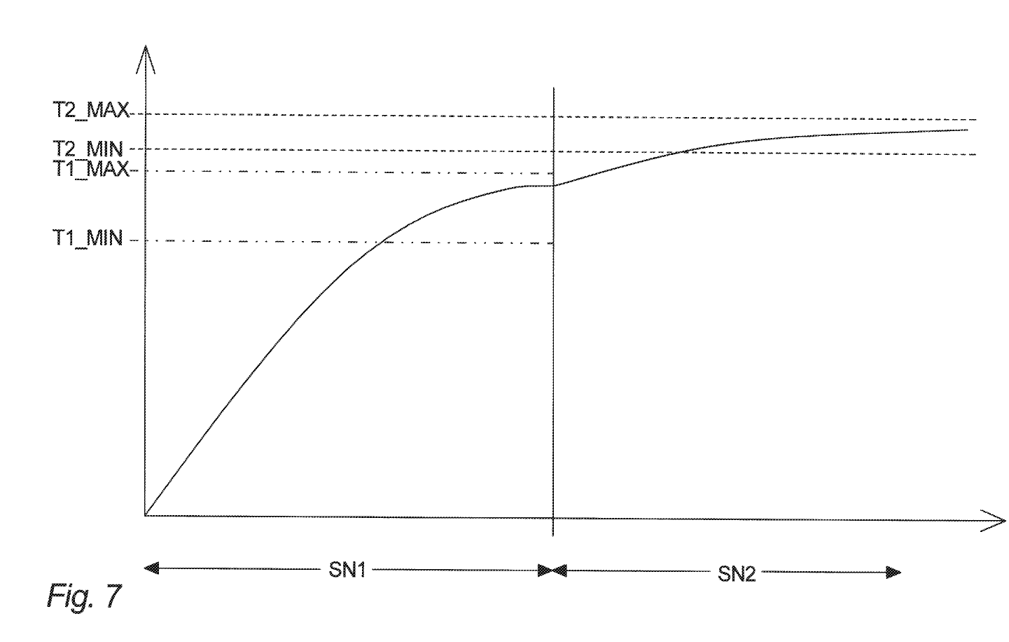

FIG. 6 and FIG. 7 illustrate different possible regulation techniques of a seed slurry temperature representation within the scope of the invention.

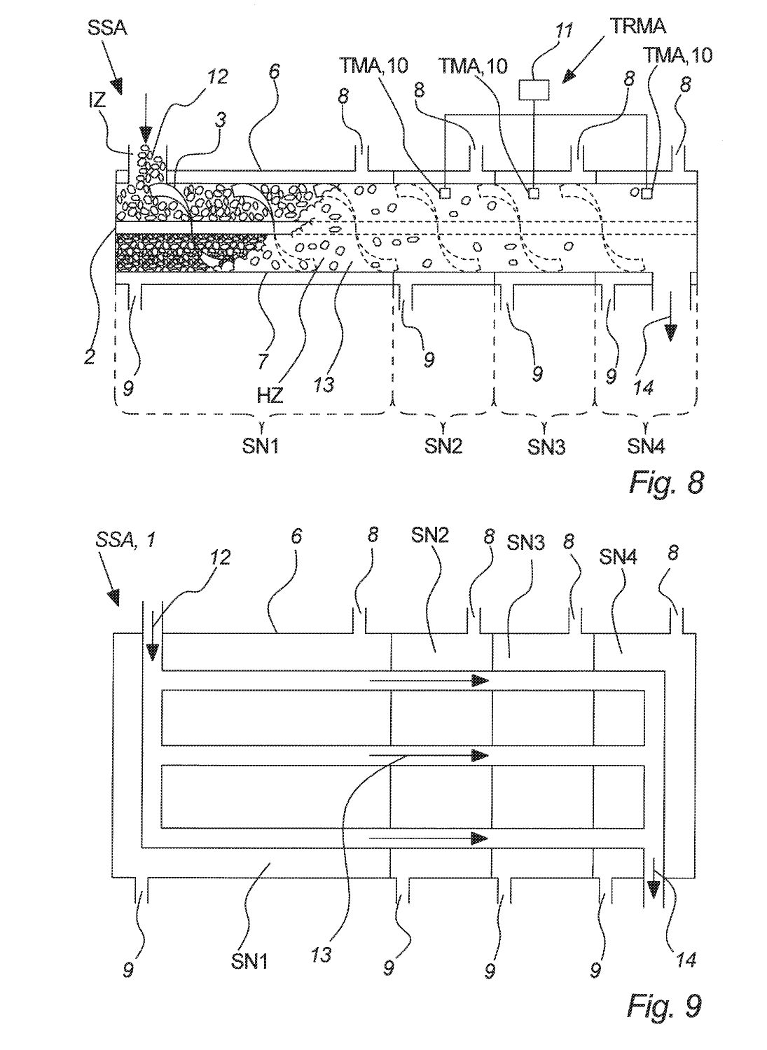

Both regulation techniques refer the X-axis as time and the Y-axis as temperature. The regulation techniques illustrates a first heating phase SN1, where a heating arrangement HA, e.g. as disclosed in the subsequent FIGS. 8 to 10, heats solid seed particles SSP with a substantial transfer of energy from the heating source to the solid seed particles SSP. During the initial phase, the heat regulation may be less strict with regard to temperature due to the fact that the temperature may have to be elevated from e.g. 20 degrees Celsius to e.g. 32 degrees Celsius. The initial phase may be characterized by the fact that the temperatures are kept within a relatively broad temperature interval defined by the T1_MIN as the minimum temperature and the T1_Max as the maximum temperature.

When the seed slurry temperature representation has reached the desired threshold or interval the heating may enter another heating phase by switching the regulation algorithm defining a much narrower temperature interval defined by T2_MIN and T2_MAX.

The two different regulation techniques illustrate a differential regulation and a proportional regulation. Any suitable regulation technique may be applied within the scope of the invention as long the desired partly melting of the solid seed slurry particles is obtained.

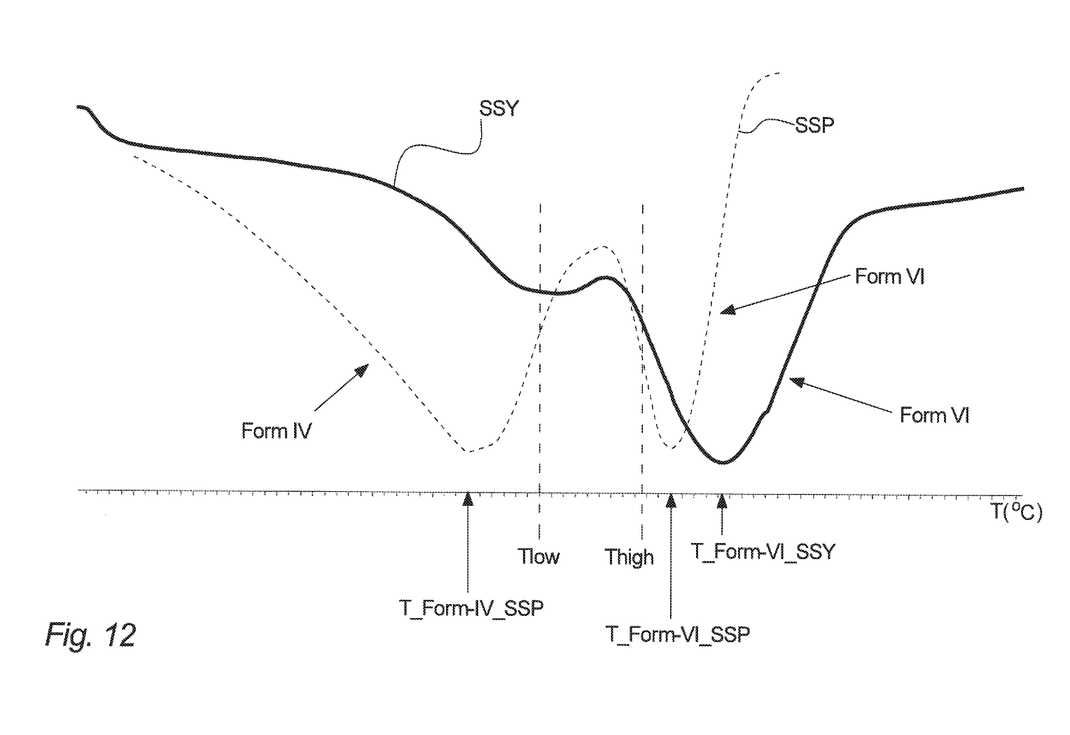

Is should, however, be noted that the finally obtained seed slurry must be kept within a very narrow temperature interval since the solid seed particles comprise a mix of different seed crystals, including Form IV and Form VI crystals. Refer to FIG. 12 for the setting of a practical temperature interval fitting the specific composition and nature of a solid seed particle.

The two illustrated heating phases may of course be performed in different heating sections of e.g. a continuous seed slurry apparatus as illustrated in FIG. 8 and FIG. 9 or the phases may be performed in one single heating section.

Referring to FIG. 8 a seed slurry apparatus SSA is illustrated according to an embodiment of the invention. The seed slurry apparatus SSA in this embodiment comprises a heat exchanger, applied for processing solid seed particles SSP into seed slurry SSY.

The seed slurry apparatus SSA comprises a heating zone HZ, and an input zone IZ.

The heating zone HZ comprises a heating arrangement HA and a temperature regulated compartment 7 in which the solid seed particles SSP are received from the input zone IZ and in which the solid seed particles SSP are processed into a seed slurry SSY. The heating arrangement HA comprises a heat transfer compartment 6, in which the temperature regulated compartment 7 is encapsulated. The heat transfer compartment 6 may be devised as a tube or having substantially tubular form, for encapsulating the temperature regulated compartment 7. The heat transfer tube 6 may comprise several sections, which may be temperature controlled individually. In this embodiment, four sections, namely a first section SN1, a second section SN2, a third section SN3, and a fourth section SN4, are shown. Each section comprises a temperature regulated fluid inlet 8 and a temperature regulated fluid outlet 9. Each section is adapted for receiving a temperature regulating fluid which could for example comprise water, brine, glycol, combinations thereof or other fluids suited for heating. By injecting temperature regulating fluid at individually controlled temperatures at the temperature regulated fluid inlet 8 of the individual sections, SN1, SN2, SN3, SN4, the temperature of, and thus the heating applied by, each individual section SN1, SN2, SN3, SN4, may be individually controlled.

Alternatively, the flow of temperature regulated fluid may be controlled to control the temperature of the individual sections SN1, SN2, SN3, SN4, while keeping the temperature of the temperature regulated fluid of each section substantially the same, e.g. by drawing the temperature regulated fluid from the same source. This may also be used in combination with controlling the temperature of the temperature regulated fluid individually for each section.

Returning to FIG. 8, the heating zone HZ comprises a shaft 2 and a conveyor screw 3 fixated to the shaft 2. The shaft 2 and the screw 3 are located the inside temperature regulated compartment 7. The screw 3 is positioned in such a way that it provides a movement of the substance through the contained in the inner surface of the temperature regulated compartment 7, when the shaft is rotating.

Alternatively, a scraper system may be used instead of illustrated the conveyor screw 3 system.

Returning to FIG. 8, the temperature regulated compartment 7 comprises a temperature representation measuring arrangement TRMA. In the embodiment illustrated on FIG. 8, the temperature representation measuring arrangement TRMA comprises a temperature measuring arrangement TMA comprising a set of temperature sensors that are positioned so that the temperature of slurry seed particles SSP and the seed slurry SSY can be measured. The measured temperature values are transmitted to a control unit CU that regulates the temperature of the second temperature regulating fluids 5 based on values from the temperature sensors. This regulating of the temperature ensures that the seed slurry is not elevated to a temperature where it is completely melted, thus ensuring that the seed functionality is retained.

In alternative some embodiments, the temperature measuring arrangement TMA may comprise only a single temperature sensor.

Also, in other embodiments, a viscosity measuring arrangement VMA may be used as alternative to the temperature measuring arrangement TMA or in combination with the temperature measuring arrangement TMA.

Returning to the embodiment of FIG. 8, the solid seed particles SSP are feed into one end of the temperature regulated compartment 7 from where some of the solid seed particles SSP come into contact with the surface of the first section SN1 of the temperature regulated compartment 7. From here the solid seed particles SSP get heated to a temperature where the solid seed particles SSP may start to gradually transform into a seed slurry SSY. Inside the temperature regulated compartment 7 a conveyor screw 3 transports the heated solid seed particles SSP and the formed seed slurry SSY, if any, over to the second section SN2. In the second section SN2 the temperature is regulated so that the heated solid seed particles SSP are further transformed to seed slurry SSY. The seed slurry SSY then exits the temperature regulated compartment 7.

By controlling the heating of the sections SN1, SN2, SN3, SN4, the solid seed particles SSP may be processed completely into a seed slurry SSY, i.e. substantially no solid seed particles SSP are left over in the output of the seed slurry apparatus SSA, while at the same time ensuring that the seed slurry SSY is not completely melted, i.e. at least some seed crystals are retained in the seed slurry SSY.

The temperature regulated compartment is regulated through the provisions of the invention to obtain a seed slurry SSY at least partly on the basis of partly melted seed composition,

The measuring on which the heating is controlled involves a measuring of a seed slurry temperature representation of the seed slurry and the heating is at least partly controlled on the basis of the measured seed slurry temperature representation.

The configuration of sensors and types of applied sensors are not shown, but the measurement types may be e.g. based on the applied techniques as illustrated in FIG. 3 to FIG. 5, where different heating stages are performed in different heating sections of the seed slurry apparatus.

The illustrated seed slurry apparatus may be controlled according to different regulation techniques and of course by means of different sensor arrangements. The sensors may vary in type, number, positioning as already explained. It should also be noted that temperature sensors may be applied in upstream heating sections as long as it is ensured that the temperature measured is not relied on too much, as a precondition for a safe measure of temperature is that the seed particles has an appropriate contact with the sensors, if a contact sensor is applied. This may of course be modified within the scope of the invention to include e.g. infrared temperature measuring. Also, it may sometimes be possible to obtain a seed slurry temperature representation of the seed slurry by measuring the temperature of a heating arrangement, e.g. a heating jacket, instead of e.g. a direct measurement of the seed slurry; this requires however that the temperature of the seed slurry corresponds to that of the heating arrangement, or may be approximated with sufficient accuracy from the temperature of the heating arrangement.

Specifically, two possible regulation techniques have already been explained and functionally illustrated in relation to FIG. 6 and FIG. 7. Other suitable regulation techniques may be applied within the scope of the invention depending on the desired process flow and heating development from solid seed particles to the final slurry.

Alternative implementation of the heating system illustrated above may also be implemented within the scope of the invention, including other types of heat sources. Different heat sources may also be applied in different heat sections of the seed slurry apparatus.

Now referring to FIG. 9 a seed slurry apparatus SSA according to a further embodiment is illustrated. This seed slurry apparatus SSA is a variant of the one described embodiment in FIG. 8. In the seed slurry apparatus SSA of FIG. 9, the temperature regulated compartment 7 is divided up into several smaller tubes, each performing the same functionality mentioned for FIG. 8. Thus, the illustrated four sections SN1, SN2, SN3, SN4 may be controlled individually by controlling the injected temperature regulating fluid as described for the embodiment of FIG. 8.

An advantage of the seed slurry apparatus of a FIG. 9 is that the division of the temperature regulated compartment may facilitate an improved temperature rise time in the temperature regulated compartment due to the fact that the heat transfer is more efficient when heating the subdivided content of the slurry stream.

The temperature regulated compartment is regulated though the provisions of the invention heating to obtain a seed slurry SSY at least partly on the basis of partly melted seed composition.

The measuring on which the heating is controlled involves a measuring of a seed slurry temperature representation of the seed slurry and the heating is at least partly controlled on the basis of the measured seed slurry temperature representation.

The configuration of sensors and types of applied sensors are not shown, but the measurement types may be e.g. based on the applied techniques as illustrated in FIG. 3 to FIG. 5, where different heating stages are performed in different heating sections of the seed slurry apparatus.

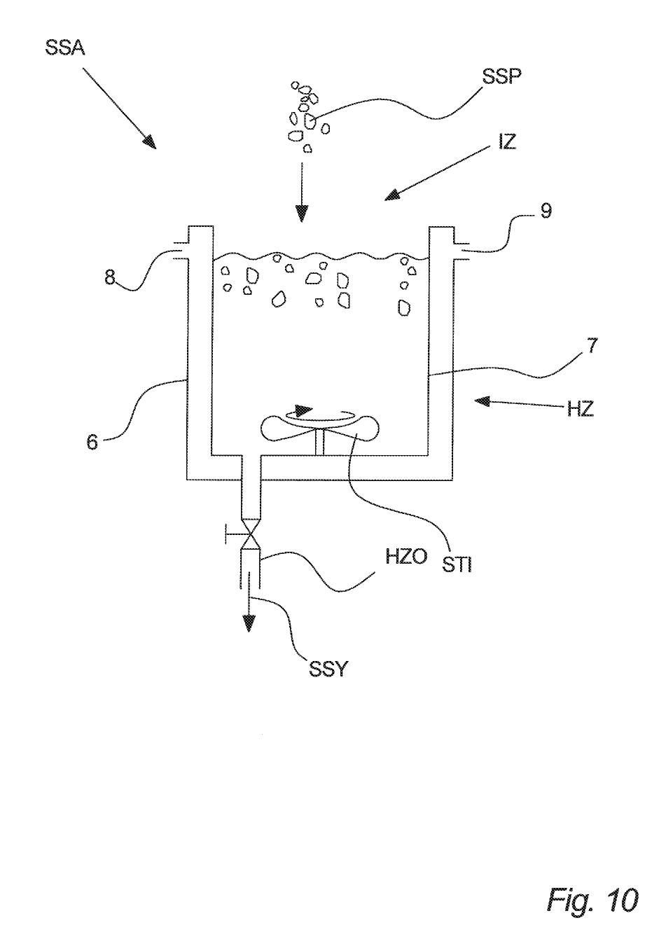

FIG. 10 illustrates a further embodiment of the invention where an apparatus is formed as a batch version of a seed slurry apparatus SSA. The seed slurry apparatus SSA in this embodiment comprises a heat exchanger, applied for processing solid seed particles SSP into seed slurry SSY.

The seed slurry apparatus SSA comprises a heating zone HZ and an input zone IZ. The solid seed particles SSP may be inputted through the input zone IZ and into the heating zone HZ.

The seed slurry apparatus comprises a temperature regulated compartment 7 in which the solid seed particles SSP may be input and in which the solid seed particles SSP are processed into a seed slurry SSY.

The heating zone HZ comprises a heat transfer compartment 6 partly encapsulating the temperature regulated compartment 7. The heat transfer compartment 6 comprises a temperature regulated fluid inlet 8 and a temperature regulated fluid outlet 9. The heat transfer compartment 6 is adapted for receiving a temperature regulating fluid which could for example comprise water, brine, glycol, combinations thereof or other fluids suited for heating.

The temperature regulated compartment 7 comprises a stirrer STI and the obtained heat slurry may be output through a heating zone outlet HZO.

The temperature regulated compartment is regulated though the provisions of the invention heating to obtain a seed slurry SSY at least partly on the basis of partly melted seed composition.

The measuring on which the heating is controlled involves a measuring of a seed slurry temperature representation of the seed slurry and the heating is at least partly controlled on the basis of the measured seed slurry temperature representation.

The configuration of sensors and types of applied sensors are not shown, but the measurement types may be e.g. based on the applied techniques as illustrated in FIG. 3 to FIG. 5. In this embodiment, though the different heating stages are performed in the same section, although it is possible to graduate the lateral temperature gradient if need may be.

When obtaining seed slurry SSY from the heat zone output HZO, solid seed particles SSP may be added to the input zone IZ to compensate for the seed slurry SSY extracted via the heat zone output HZO. This may for example be done continuously, so as to keep a relative constant level of solid seed particles SSP and seed slurry SSY in the heating zone HZ, or in a batch-wise manner e.g. when the level of solid seed particles SSP and seed slurry SSY in the heating zone HZ is below a predetermined threshold. Alternatively, no solid seed particles SSP are added, and the heating zone HZ is allowed to be more or less completely drained before feeding more solid seed particles SSP into the input zone IZ.

FIG. 12 illustrates two principle DSC curves related to a specifically chosen composition of a solid seed particle. The illustrated seed composition may reflect a specific formulation based on a shea stearin fraction having a relatively high content of StOSt-triglycerides. The dotted line SSP indicates the DSC melt peak positions (i.e. endotherm melt peak positions) of a solid seed particle to be used in the specific application and the solid line SSY indicates the DSC melt peak positions of the finally obtained seed slurry SSY.

For practical applications the melting thermogram obtained by DSC may be somewhat altered according to the specific composition, for example the specific content of triglycerides, hereunder StOSt, AOA, BOB, and LigOLig-triglycerides. Moreover, any further content may, at least to some degree modify the specific melting thermogram obtained by DSC, such as for example the content of emulsifiers, preservatives, sugar, cocoa powder, if any.

An immensely advantageous feature of the present invention is that the solid seed particles may be applied for seeding at high temperatures without requiring significant processing skills at the final chocolate seeding and manufacturing site. An advanced seeding may be obtained simply by applying a particular chosen seed in solid form thereby obtaining a seed slurry, which may be used in a subsequent chocolate seeding by a simply mixing process at a designated temperature. When choosing the desired heating temperature, this should however be chosen within the illustrated temperature interval Tlow and Thigh and the temperature interval must simply be selected to be as close to T_Form-VI_SSP and T_Form-VI_SSY temperatures as possible without risking melting the Form VI crystals at any time during the heating while at the same time at least ensuring that the Form IV crystals of the particles/slurry are melted. There are some technical discussions in learned societies about what a difference between Form V and Form VI crystal actually is, but according to the present invention it is preferred to get as close to the Form VI temperature as possible thereby improving the finally obtained seeded chocolate. The form VI temperature may for example be identified by DSC measurements, e.g. as the temperatures T_Form-VI_SSP and T_Form-VI_SSY indicated on FIG. 12, and described above.

It should be noted that an automated heating is preferred within the scope of the invention to generally ensure that a correct heating is applied on the solid seed particles.

### EXAMPLES

### DSC Analysis

In the following examples, slurry samples were analyzed by Differential Scanning Calorimetry (DSC). This was done by a METTLER TOLEDO DSC 823e with a HUBER TC45 immersion cooling system. 40+/−4 mg of slurry samples were hermetically sealed in a 100 microliter aluminum pan, with an empty pan as reference. Slurry samples were heated from 32.0 degrees Celsius to 48.0 degrees Celsius at a rate of 3 degrees Celsius per minute to produce a DSC melting thermogram.

### Brookfield Viscosity Analysis

Samples were analyzed by a Brookfield DV-III (software version 3.3) with a Huber ministat 240 cooling system. 10 mL of sample with a temperature between 27 and 35 degrees Celsius were placed in a SC4-13RPY sample chamber. The sample chamber was at the same temperature as the sample. Spindle SC4-27 was placed into the sample in the sample chamber. Samples were initially stirred at isothermal temperature (27-35 degrees Celsius) for 2 minutes at 50 rotations per minute (RPM). Then 30 seconds intervals at 5, 10, 15, 20, 25, 30, 35, 40, 45, 50 RPM. Experiments were performed in duplicate. Brookfield Plastic viscosity (BPV) is given in Centipoise (cP) and Brookfield Yield Value (BYV) is given in Dynes per square centimeter.

### Shea Stearin IV 36

### Triglyceride Composition (Most Abundant):

TABLE 1
Content of most abundant triglycerides, given in
% by weight of the total triglyceride content.

| | Amount in weight % of the |
|---|---|
| Triglyceride | total triglyceride content |
| StOSt | 67% |
| POSt | 8% |
| StOA | 4% |
| StOO | 6% |
| StLiSt | 7% |
| Others | 8% |

St denotes Stearic acid, O denotes Oleic acid, P denotes Palmitic acid, A denotes Arachidic acid, and Li denotes Linoleic acid.

The total content of SatOSat-triglycerides is about 80% of the triglyceride content, where Sat denotes saturated fatty acids, and O denotes Oleic acid.

### Example 1

Solid seed particles made from a Shea Stearin IV 36 have been processed into a slurry by means of a seed slurry apparatus by a process according to FIG. 1, by subjecting the solid seed particles to temperatures between 39 and 45 degrees Celsius under stirring and strict temperature control. Samples were extracted from the seed slurry at 8 hours after obtaining the seed slurry.

A set of the samples extracted from the seed slurry apparatus were transported from the seed slurry apparatus to the Brookfield viscometer for measurement and analyzed according to “Brookfield viscosity analysis”. Measured values of temperatures and corresponding viscosities are given in table 2.

TABLE 2
Results of viscosity measurements of Brookfield viscosity
measurements performed by a Brookfield DV-III

| | Measured values | | | | | |
|---|---|---|---|---|---|---|
| Temperature | 39.0 | 39.5 | 40.0 | 40.5 | 41.0 | 45.0 |
| (degrees Celsius) | | | | | | |
| BPV (cP) | 696 | 477 | 337 | 88 | 20 | 12 |
| BYV (Dynes/cm²) | 56 | 55 | 50 | 25 | 1 | 2 |

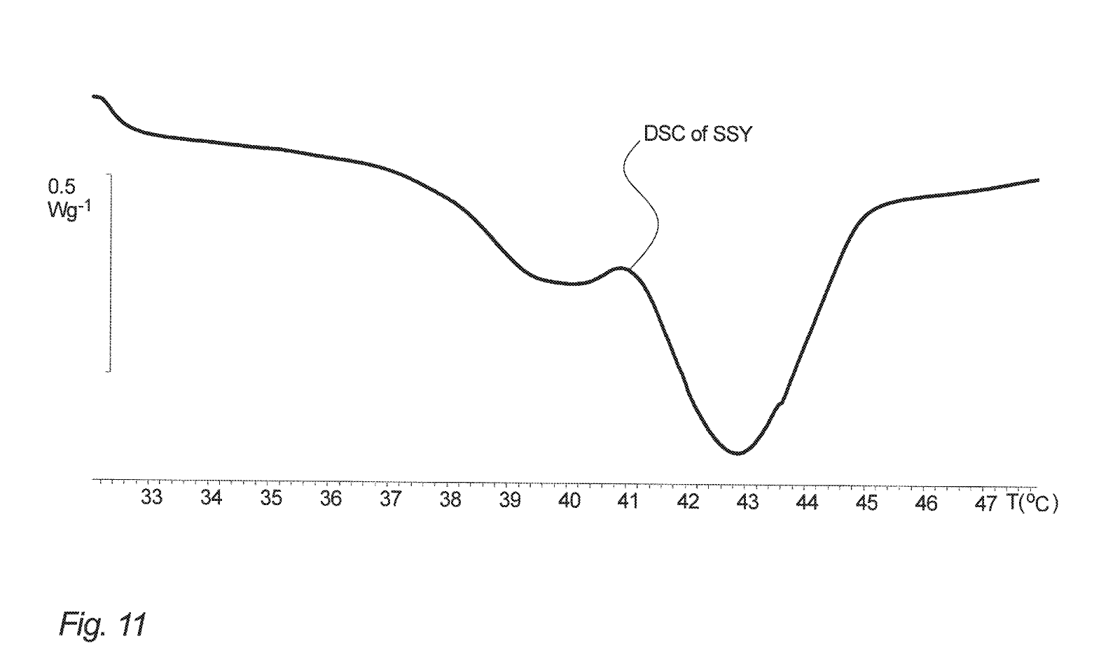

A set of the samples extracted from the seed slurry apparatus were analyzed according to the “Brookfield viscosity analysis”. The produced DSC melting thermogram is illustrated as the solid line in FIG. 11. An endotherm melt peak positions is identified at approximately 42.8-43.0 degrees Celsius.

The solid seed particles may be made according to example 2.

### Example 2—Solid Seed Particles

Solid seed particles in the form of seed flakes were produced from Shea Stearin IV 36. The Shea Stearin IV 36 was subjected to a crystallization zone CZ, where the crystallization zone was provided in a Scraped Surface Heat Exchanger. The Scraped Surface Heat Exchanger has an initial feed tank, from where the Shea Stearin IV 36 was fed through three subsequent temperature zones, A1, A2, and A3. The parameters and settings of the Scraped Surface Heat Exchanger and measured slurry temperatures are listed in table 3.

TABLE 3
Settings of the Scraped Surface Heat Exchanger.
Scraped Surface Heat Exchanger

| | |
|---|---|
| Feed tank temperature (degrees Celsius) | 62.3 |
| Product flow (kilogram per hour) | 80 |
| Total retention time in Scraped Surface Heat Exchanger | 25.8 |
| Scraped Surface Heat Exchanger rotational speed (Rotations per | 800 |
| minute) | |
| Temperature of cooling jacket of A1 (degrees Celsius) | 10 |
| Slurry temperature at outlet from A1 (degrees Celsius) | 29.3 |
| Temperature of cooling jacket of A2 (degrees Celsius) | 0 |
| Slurry temperature at outlet from A2 (degrees Celsius) | 22.6 |
| Temperature of cooling jacket of A3 (degrees Celsius) | Off/20 |
| Slurry temperature at outlet from A3 (degrees Celsius) | 25.7 |

Note that “Off” denotes no active temperature control in the given step, where ambient temperature was about 20 degrees Celsius.

The obtained product from the Scraped Surface Heat Exchanger was subjected to a transformation zone to obtain a transformed edible fat. The transformation zone comprised a transformation tank, a stirrer, and a temperature controller. The crystallization zone was operated according to the parameters and settings as given in table 4.

TABLE 4
Settings of the Transformation Zone TZ.
Settings of the Transformation Zone TZ.

| | |
|---|---|
| Transformation tank capacity (liters) | 30 |
| Transformation tank stirring speed (Rotations per minute) | 35 |
| Transformation tank temperature (degrees Celsius) | 39.5 |
| Retention time in transformation zone (hours) | 25 |

The transformed edible fat extracted from the transformation zone output was subjected to particulation in a particulation zone to obtain samples of chocolate seed particle product in the form of seed flakes. The particulation zone comprised a drum having a controllable drum surface temperature. The particulation zone was operated according to the parameters and settings as given in table 5.

TABLE 5
Settings of the particulation zone.
Particulation zone

| | |
|---|---|
| Flaker capacity (kilogram per hour) | 10 |
| Flaker drum surface temperature (degrees Celsius) | −14 |
| Temperature of HSC slurry immediately prior to | 39.5 |
| flaking (S5, S6) (degrees Celsius) | |
| Contact time slurry on flaker (seconds) | 3 |

In further applications the composition of solid seeds particles to be applied according to embodiments of the invention may be given according to the below table 6.

TABLE 6
Different compositions of solid seed particles mainly based on StOSt

| Triglyceride | Amount in weight % of the total triglyceride content | | | | | |
|---|---|---|---|---|---|---|
| StOSt | 41% | 50% | 61% | 74% | 85% | 91% |
| Others | 39% | 50% | 39% | 24% | 15% | 9% |

In further applications the composition of solid seeds particles to be applied according to embodiments of the invention may be given according to the below table 7. It should be noted that the processing temperature in particular of the heating zone must be adapted to the applied functional triglyceride. In the case of AOA applied as the functional triglyceride as indicated in table 7 below, the temperature may advantageously be increased to obtain the desired seed slurry.

TABLE 7
Different compositions of solid seed particles mainly based on AOA

| Triglyceride | Amount in weight % of the total triglyceride content | | | | | |
|---|---|---|---|---|---|---|
| AOA | 53% | 55% | 60% | 65% | 74% | 85% |
| Others | 47% | 45% | 40% | 35% | 26% | 15% |

In further applications the composition of solid seeds particles to be applied according to embodiments of the invention may be given according to the below table 8. It should be noted that the processing temperature in particular of the heating zone must be adapted to the applied functional triglyceride. In the case of BOB applied as the functional triglyceride as indicated in table 8 below, the temperature may advantageously be increased to obtain the desired seed slurry.

TABLE 8
Different compositions of solid seed particles mainly based on BOB

| Triglyceride | Amount in weight % of the total triglyceride content | | | | | |
|---|---|---|---|---|---|---|
| BOB | 40% | 42% | 45% | 67% | 69% | 74% |
| Others | 60% | 58% | 55% | 33% | 31% | 26% |

1-50. (canceled)

51. A method for producing a seed slurry (SSY) in a seed slurry apparatus (SSA) from solid seed particles (SSP), the seed slurry apparatus (SSA) comprising an input zone (IZ) and a heating zone (HZ), the input zone (IZ) feeding the heating zone (HZ) and the heating zone (HZ) comprising a heating arrangement (HA), said method comprising the steps of:
feeding the solid seed particles (SSP) from the input zone (IZ) into the heating zone (HZ), the solid seed particles having a seed composition, the seed composition comprising triglycerides,
heating said seed composition in said heating zone (HZ) by means of said heating arrangement (HA) to obtain a seed slurry (SSY) at least partly on the basis of partly melted seed composition,
wherein said heating involves measuring a seed slurry temperature representation of the seed slurry and said heating is at least partly controlled on the basis of the measured seed slurry temperature representation.

52. The method according to claim 51, wherein said heating is controlled to obtain a seed slurry comprising seed crystals.

53. The method according to claim 51, wherein said heating involves measuring a seed slurry temperature representation of the seed slurry and said heating is at least partly controlled on the basis of the measured seed slurry temperature representation to obtain a seed slurry comprising seed crystals.

54. The method according to claim 51, wherein said seed composition comprises seed crystals.

55. The method according to claim 51, wherein said solid particles comprise seed crystals.

56. The method according to claim 51, wherein said seed slurry comprises seed crystals.

57. The method according to claim 51, wherein said seed composition comprises triglycerides in an amount of 60.0-99.9% by weight of said seed composition.

58. The method according to claim 51, wherein said seed composition comprises SatOSat-triglycerides in an amount of 40.0-99.9% by weight of said triglycerides, wherein Sat is a saturated fatty acid, and wherein O stands for oleic acids.

59. The method according to claim 51, wherein said seed composition comprises 40.0-99.9% by weight of said triglycerides having C18-C24 saturated fatty acids in the sn-1 and sn-3 positions and oleic acid in the sn-2 position.

60. The method according to claim 51, wherein a weight-ratio in the seed composition between triglycerides having C18-C24 saturated fatty acids in the sn-1 and sn-3 positions and oleic acid in the sn-2 position and triglycerides having C16-C24 saturated fatty acids in the sn-1 and sn-3 positions and oleic acid in the sn-2 position is between 0.40-0.99.

61. The method according to claim 51, wherein said seed composition comprises StOSt-triglycerides in an amount of 30.0-99.0% by weight of said triglycerides, wherein St stands for stearic acid and O stands for oleic acid.

62. The method according to claim 51, wherein said seed composition comprises AOA-triglycerides in an amount of 30.0-99.0% by weight of said triglycerides, wherein A stands for arachidic acid and O stands for oleic acid.

63. The method according to claim 51, wherein said seed composition comprises BOB-triglycerides in an amount of 30.0-99.0% by weight of said triglycerides, wherein B stands for behenic acid and O stands for oleic acid.

64. The method according to claim 51, wherein said seed composition comprises LigOLig-triglycerides in an amount of 30.0-99.0% by weight of said triglycerides, wherein Lig stands for lignoceric acid and O stands for oleic acid.

65. The method according to claim 51, wherein said seed slurry temperature representation is measured in the heating zone (HZ), at a heating zone output (HZO), and/or at an output (0) of said a seed slurry apparatus (SSA).

66. The method according to claim 51, wherein said seed slurry temperature representation is measured at a point where it is possible to derive or obtain a temperature of the produced seed slurry.

67. The method according to claim 51, wherein measuring said seed slurry temperature representation comprises measuring a seed slurry temperature.

68. The method according to claim 51, wherein measuring said seed slurry temperature representation comprises measuring a seed slurry viscosity.

69. The method according to claim 51, wherein said heating is at least partly controlled on the basis of the measured seed slurry temperature representation to provide a slurry having a temperature below a maximum temperature (Tmax).

70. The method according to claim 51, wherein said heating is at least partly controlled on the basis of the measured seed slurry temperature representation to provide a slurry having a viscosity below a maximum viscosity (VISCMAX).

71. The method according to claim 51, wherein said seed composition being partly melted has a melted content of 40-99% by weight.

72. The method according to claim 51, wherein the heating is controlled to a temperature below the endotherm melt peak position of the highest melting crystal polymorphic form of StOSt-triglycerides.

73. The method according to claim 51, wherein the heating is controlled to a temperature above the endotherm melt peak position of the third-highest melting crystal polymorphic form of StOSt-triglycerides.

74. The method according to claim 51, wherein the heating is controlled to a temperature below the endotherm melt peak position of the highest melting crystal polymorphic form of AOA-triglycerides.

75. The method according to claim 51, wherein the heating is controlled to a temperature above the endotherm melt peak position of the third-highest melting crystal polymorphic form of AOA-triglycerides.

76. The method according to claim 51, wherein the heating is controlled to a temperature below the endotherm melt peak position of the highest melting crystal polymorphic form of BOB-triglycerides.

77. The method according to claim 51, wherein the heating is controlled to a temperature above the endotherm melt peak position of the third-highest melting crystal polymorphic form of BOB-triglycerides.

78. The method according to claim 51, wherein the heating is controlled to a temperature below the endotherm melt peak position of the highest melting crystal polymorphic form of LigOLig-triglycerides.

79. The method according to claim 51, wherein the heating is controlled to a temperature above the endotherm melt peak position of the third-highest melting crystal polymorphic form of LigOLig-triglycerides.

80. The method according to claim 51, wherein the seed composition is partly melted within a temperature range from Tlow to Thigh.

81. The method according to claim 80, wherein said heating is controlled to keep the temperature of the seed composition within the temperature range from Tlow to Thigh.

82. The method according to claim 51, wherein the temperature Tlow is the temperature at which 40-80% by weight of said triglycerides are melted.

83. The method according to claim 51, wherein the temperature Thigh is the temperature at which 65-99% by weight of said triglycerides are melted.

84. The method according to claim 51, wherein the temperature Tlow is at least 25 degrees Celsius.

85. The method according to claim 51, wherein the temperature Thigh is no more than 42 degrees Celsius.

86. The method according to claim 51, wherein the heating is controlled to obtain a seed slurry having a Brookfield Plastic viscosity of less than 1500 cP (BPV).

87. The method according to claim 51, wherein the heating is controlled to obtain a seed slurry having a Brookfield Plastic viscosity of at least 40 cP (BPV).

88. The method according to claim 51, wherein said seed composition comprises triglycerides obtained from vegetable sources.

89. The method according to claim 51, wherein said seed composition comprises triglycerides obtained from non-vegetable sources.

90. The method according to claim 51, wherein said solid seed particles exhibit an endotherm melt peak position at a value being about 40 degrees Celsius or higher, said endotherm melt peak position being measured by Differential Scanning Calorimetry by heating samples of 40+/−4 mg of said solid seed particles from 32 degrees Celsius to 65 degrees Celsius at a rate of 3 degrees Celsius per minute to produce a melting thermogram defining said endotherm melt peak position.

91. The method according to claim 51, wherein said heating is controlled to obtain said seed slurry exhibiting an endotherm melt peak position at a value being about 40 degrees Celsius or higher, said endotherm melt peak position being measured by Differential Scanning Calorimetry by heating samples of 40+/−4 mg of said solid seed particles from 32 degrees Celsius to 65 degrees Celsius at a rate of 3 degrees Celsius per minute to produce a melting thermogram defining said endotherm melt peak position.

92. The method according to claim 51, wherein said step of heating comprises mixing said solid seed particles (SSP) and/or said seed slurry (SSY).

93. A seed slurry apparatus (SSA) for producing a seed slurry from solid seed particles (SSP) having a seed composition, the seed composition comprising triglycerides, said seed slurry apparatus (SSA) comprising:
a heating zone (HZ),
a heating arrangement (HA) arranged to heat the seed composition in said heating zone (HZ),
a temperature representation measuring arrangement (TRMA) arranged to measure a seed slurry temperature representation of said seed slurry (SSY), and
a control unit (CU),
wherein said temperature representation measuring arrangement (TRMA) is arranged to transmit a measuring signal (MS) to said control unit (CU), said measuring signal (MS) being based at least partly on the measured seed slurry temperature representation, wherein said control unit (CU) is arranged to control the heating arrangement (HA) based at least partly on the measuring signal (MS).

94. The seed slurry apparatus (SSA) according to claim 93, wherein said temperature representation measuring arrangement (TRMA) comprises a temperature measuring arrangement (TMA) adapted to measure at least one temperature.

95. The seed slurry apparatus (SSA) according to claim 93, wherein said temperature representation measuring arrangement (TRMA) comprises a viscosity measuring arrangement (VMA) adapted to measure at least one viscosity.

96. The seed slurry apparatus (SSA) according to claim 93, wherein said seed slurry apparatus (SSA) further comprises a mixing arrangement, wherein the mixing arrangement (STI, 3) is arranged in the heating zone (HZ) to mix said solid seed particles (SSP) and/or said seed slurry (SSY).

97. The method according to claim 93, wherein the seed slurry is used in the production of confectionary products.
